(19) United States
(12) Patent Application Publication
(10) Pub. No.: US 2026/0264520 A1
(43) Pub. Date: Sep. 10, 2026

(54) DRIVING MODE DISPLAY DEVICE AND DRIVING MODE DISPLAY METHOD

(71) Applicant: LG ELECTRONICS INC., Seoul (KR)

(72) Inventors: Sujung YOO, Seoul (KR); Mingyeong YUN, Seoul (KR); Sohee YUN, Seoul (KR); Junghoon SON, Seoul (KR); Kyungjae IM, Seoul (KR); Minah HAN, Seoul (KR); Ahyeon YOO, Seoul (KR)

(73) Assignee: LG ELECTRONICS INC., Seoul (KR)

(21) Appl. No.: 19/162,138

(22) PCT Filed: Mar. 4, 2024
(86) PCT No.: PCT/KR2024/002720

§ 371 Date: Sep. 4, 2025

(30) Foreign Application Priority Data
Mar. 6, 2023 (KR) 10-2023-0029319
Dec. 27, 2023 (KR) 10-2023-0193433

(51) Int. Cl. B60K 35/28; B60K 35/21; B60K 35/22; B60W 50/14; B60W 60/00

(52) U.S. Cl. CPC B60K 35/28; B60K 35/213; B60K 35/22; B60W 50/14; B60W 60/0051; B60W 60/0053; B60K 2360/162; B60K 2360/166; B60K 2360/167; B60K 2360/172; B60K 2360/175; B60K 2360/177; B60W 2050/146

(57) ABSTRACT

An autonomous driving mode display device of the present invention comprises: a receiving unit that receives a front image obtained through a camera of a vehicle, map data of the vehicle, and sensing information; a driving mode detection unit that detects an autonomous driving mode of the vehicle; and a processor that generates a virtual steering wheel representing the detected autonomous driving mode and controls the generated virtual steering wheel to be displayed on the front image. While the vehicle is traveling, the processor may recognize the driving state of the vehicle on the basis of received map data and sensing information and display the recognized driving state in synchronization with the virtual steering wheel. Thus, driver anxiety caused by changes in driving states during autonomous driving may be relieved.

### TECHNICAL FIELD

The present disclosure relates to a driving mode display device and an autonomous driving mode display method and, more particularly, to a driving mode display device and an autonomous driving mode display method that are capable of performing a display to enable a driver to intuitively recognize a current driving mode and a current state of a vehicle.

### BACKGROUND ART

Vehicles are apparatuses that move in a direction desired by an occupant. An automobile is a representative example of such a vehicle.

A trend has emerged in which vehicles are equipped with various sensors and electronic devices to improve user convenience. Particularly, to enhance user convenience, extensive research has been conducted on Advanced Driver Assistance Systems (ADAS). Moreover, research directed to autonomous vehicles has actively progressed.

The term ‘autonomous driving’ refers to a system in which the vehicle is capable of determining driving behavior and operating without input from the occupant. This autonomous driving may be categorized into progressive stages ranging from non-automation to full automation, depending on the degree to which the system is involved in driving and the extent to which the driver controls the vehicle.

During autonomous driving of the vehicle, the driver may be interested in evaluating how effectively the vehicle is executing autonomous driving operations and whether an engagement state of the autonomous driving move is stable. In addition, during the autonomous driving of the vehicle, the driver may experience a sense of uncertainty due to the inability to predict the vehicle's driving behavior and simultaneously comprehend the surrounding environment detected by the vehicle. Moreover, when it is determined that a switch to manual driving is required due to the surrounding environment during the autonomous driving of the vehicle, a corresponding notification needs to be effectively provided to the driver.

In this regard, U.S. Patent Application Publication No. 2024/0005576 A1 (hereinafter referred to as ‘Patent Document 1’) discloses that the detected location of an obstacle and the number of times the obstacle has been detected are displayed on a vehicle's travel path. In addition, U.S Patent Application Publication US 2024/0010216 A1 (hereinafter referred to as ‘Patent Document 2’) discloses that a guide indicating an avoidance steering path relative to a reference lane is displayed when an obstacle is detected during vehicle driving.

However, Patent Document 1 and Patent Document 2 assist a driver during vehicle driving and provide only limited information regarding the guidance and activation of a driving state. In addition, even when useful information is provided, inexperienced drivers may not intuitively recognize what actions need to be taken or what the information signifies. Accordingly, there remains a problem in that a sense of uncertainty and apprehension that may be experienced by the driver is not relieved.

### DISCLOSURE OF INVENTION

### Technical Problem

Objects of the present disclosure are to address the above-mentioned problems and other related problems.

One object of some embodiments of the present disclosure is to provide a driving mode display device and a driving mode display method that are capable of minimizing a sense of uncertainty and apprehension that may be experienced by a driver during autonomous driving of a vehicle.

Another object of some embodiments of the present disclosure is to provide a driving mode display device and a driving mode display method that are capable of enabling a driver to intuitively recognize the current engagement state of a vehicle's autonomous driving mode and of providing the driver with information about the surrounding environment and a travel path in real time during autonomous driving of the vehicle, thereby enhancing a sense of security to the driver.

A further object of some embodiments of the present disclosure is to provide a driving mode display device and a driving mode display method that are capable of displaying a change in steering during autonomous driving of the vehicle in synchronization with a virtual steering wheel, thereby minimizing a sense of uncertainty that may be experienced by a driver.

Another object of some embodiment of the present disclosure is to provide a driving mode display device and a driving mode display method that are capable of providing an advanced driver assistance system (ADAS) setting appropriate to a driver level and providing information about an appropriate point in time for a switch between an autonomous driving mode and a manual driving mode by detecting the necessity for such a switch.

### Solution to Problem

To accomplish the above-mentioned objects and other related objects, a driving mode display device according to an embodiment of the present disclosure is capable of displaying a virtual steering wheel on a forward-facing image such that a driver is enabled to intuitively recognize that a vehicle is being driven in an autonomous driving mode.

In addition, the driving mode display device is capable of controlling the display of a change in steering, occurring during driving of a vehicle, on a virtual steering wheel, thereby relieving a sense of uncertainty due to a change in a driving state during autonomous driving of the vehicle.

According to one aspect of the present disclosure, there is provided a driving mode display device including: a reception unit that receives a forward-facing image acquired through a camera within a vehicle, and the vehicle's map information and sensing information; a driving mode detection unit that detects the vehicle's autonomous driving mode; and a processor that generates a virtual steering wheel representing the detected autonomous driving mode and controls the generated virtual steering wheel to be displayed on the forward-facing image. The processor detects the vehicle's driving state on the basis of the map data and the sensing information during driving of the vehicle and controls the display of the virtual steering wheel such that the recognized driving state is displayed in synchronization with the virtual steering wheel.

According to an embodiment, in the driving mode display device, the driving mode detection unit may detect an auxiliary driving setting matching a recognized driver level when a driver's entry into the vehicle is detected. In addition, in accordance with the detected auxiliary driving setting, the processor may display a virtual graphic object representing a driving situation detected on the basis of the map data and the sensing information, along with the virtual steering wheel.

According to an embodiment, in the driving mode display device, the processor may select an autonomous driving mode to be activated, based on the reception of a user input for selecting one autonomous mode from among a plurality of autonomous driving modes, and may display the visually distinguishable virtual steering wheel such that the selected autonomous driving mode is intuitively recognizable.

According to an embodiment, in the driving mode display device, in a first autonomous driving mode, the processor may display a first graphic object representing the vehicle's travel path and direction, along with a first virtual steering wheel. In a second autonomous driving mode, the processor may display the first graphic object and a second graphic object representing surrounding environment information of the vehicle, along with a second virtual steering wheel.

According to an embodiment, in the driving mode display device, the sensing information may include steering angle information of the vehicle, and the processor may change the display of the virtual steering wheel on the basis of the received steering angle information such that the virtual steering wheel is rotated in synchronization.

According to an embodiment, in the driving mode display device, the processor may synchronously display the vehicle's travel path, varying according to the rotation of the virtual steering wheel, on a forward-facing image.

According to an embodiment, in the driving mode display device, the processor may display a visual image, representing an engagement state of the detected autonomous driving mode, on the virtual steering wheel.

According to an embodiment, in the driving mode display device, the processor may recognize, based on the vehicle's sensing information, that an engagement state of the detected autonomous driving mode is changed, and may display a visual image, indicating the changed engagement state, on the virtual steering wheel.

According to an embodiment, in the driving mode display device, the processor may determine that a switch to a manual driving mode is required depending on the engagement state of the autonomous driving mode, and may control the display of a virtual graphic image indicating the switch to the manual driving mode on the forward-facing image.

According to an embodiment, in the driving mode display device, the processor may provide a control signal for the switch from the vehicle's autonomous driving mode to the manual driving mode to the vehicle based on the detection of a hand gesture on a steering wheel of the vehicle after the virtual graphic image is displayed on the physical steering wheel.

According to an embodiment, in the driving mode display device, when the vehicle switches to the manual driving mode while the virtual steering wheel is displayed, the processor may no longer display the virtual steering wheel on the forward-facing image.

According to an embodiment, in the driving mode display device, the reception unit may receive driver state information recognized on the basis of the camera installed within the vehicle. While the vehicle's autonomous driving mode is not detected, based on the received driver state information, the processor may display a virtual graphic object, providing guidance for a switch to the autonomous driving mode, on the forward-facing image.

According to another aspect of the present disclosure, there is provided an autonomous driving state display method including: receiving a forward-facing image acquired through a camera within a vehicle, and the vehicle's map information and sensing information; detecting the vehicle's autonomous driving mode; displaying a virtual steering wheel, representing the detected autonomous driving mode, on the forward-facing image; and displaying the recognized driving state in synchronization with the virtual steering wheel after recognizing the vehicle's driving state on the basis of the map data and the sensing information during driving of the vehicle.

### Advantageous Effects of Invention

In a vehicular driving mode display device and a vehicular driving mode display method, according to the present disclosure, when a vehicle starts autonomous driving, a virtual steering wheel is displayed to enable a driver to intuitively recognize the start of the autonomous driving, and a change in the vehicle's steering is displayed in synchronization with the virtual steering wheel, thereby minimizing a sense of uncertainty and apprehension that may be experienced by the driver due to a sudden change in steering during autonomous driving of the vehicle.

In addition, in the driving mode display device and the driving mode display method, according to the present disclosure, the screen can be configured using an advanced driver assistance system (ADAS) setting that is appropriate to a driver level, thereby enabling the driver to more easily recognize provided information. Furthermore, different settings can be provided for stages of the autonomous driving, thereby enabling the driver to intuitively recognize the current driving mode.

In addition, in the driving mode display device and the driving mode display method, according to the present disclosure, a current engagement state of the vehicle's autonomous driving mode can be intuitively recognized through a change in the display of the virtual steering wheel. The point in time at which a switch to a manual driving mode is required can be exactly anticipated, and preparations for the switch thereto can be made accordingly.

In addition, in the driving mode display device and the driving mode display method, according to the the present disclosure, during driving of the vehicle, a travel path and information recognized from surrounding road conditions are provided in an easily recognizable format.

### BRIEF DESCRIPTION OF DRAWINGS

FIG. 1 is a view illustrating an example of a vehicle in accordance with an embodiment of the present disclosure.

FIG. 2 is a set of views illustrating the vehicle in accordance with the embodiment of the present disclosure from various angles.

FIGS. 3 and 4 are views each illustrating the interior of the vehicle in accordance with the embodiment of the present disclosure.

FIGS. 5 and 6 are views that are referenced to describe various objects associated with vehicle driving in accordance with the embodiment of the present disclosure.

FIG. 7 is a block diagram that is referenced to describe a driving mode display device for a vehicle, according to an embodiment of the present disclosure.

FIG. 8 is a block diagram that is referenced to describe the detailed configuration of the driving mode display device according to the embodiment of the present disclosure, and a related configuration of the vehicle.

FIG. 9A is a set of views illustrating a navigation screen according to an embodiment of the present disclosure. FIG. 9B is a set of views that are referenced to describe an operation of generating a navigation screen.

FIG. 10 is a representative flowchart that is referenced to describe an autonomous driving mode display method according to an embodiment of the present disclosure.

FIGS. 11A to 11D are views that are referenced to describe an operation scenario where the autonomous driving mode display device according to the embodiment of the present disclosure detects a driver's entry into the vehicle and performs an auxiliary driving setting that matches the driver level of the driver.

FIGS. 12A and 12B are views that are referenced to describe a method of displaying a virtual steering wheel in a semi-autonomous driving mode in the driving mode display device according to the embodiment of the present disclosure.

FIGS. 13 and 14 are views that are referenced to describe the virtual steering wheel in the fully autonomous driving mode in the driving mode display device according to the embodiment of the present disclosure.

FIG. 15 is a view that is referenced to a method of providing an engagement state of the autonomous driving mode and information about a recognized object in the vicinity of the vehicle in the driving mode display device according to the embodiment of the present disclosure.

FIGS. 16A and 16B are views that are referenced to describe a method of displaying driving-related information, varying according to whether the current driving mode is a manual driving mode or the autonomous driving mode, in the driving mode display device according to the embodiment of the present disclosure.

FIGS. 17A and 17B are views that are referenced to describe a method of displaying a warning on a per-risk level basis in the driving mode display device according to the present disclosure during driving of the vehicle in the autonomous driving mode.

FIG. 18 is a view that is referenced to describe a method of displaying the detection of the driver's drowsiness state in the driving mode display device according to the embodiment of the present disclosure.

FIG. 19 is a view that is referenced to describe a method of providing a notification indicating the point in time for the switch to the manual driving mode in the driving mode display device according to the embodiment of the present disclosure during autonomous driving of the vehicle.

FIGS. 20A and 20B are views that are referenced to describe a method providing customized information to the driver during the driving of the vehicle in the driving mode display device according to the embodiment of the present disclosure.

### MODE FOR THE INVENTION

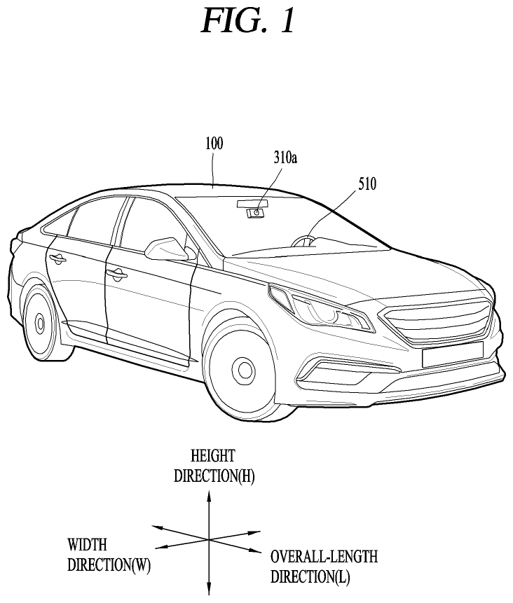

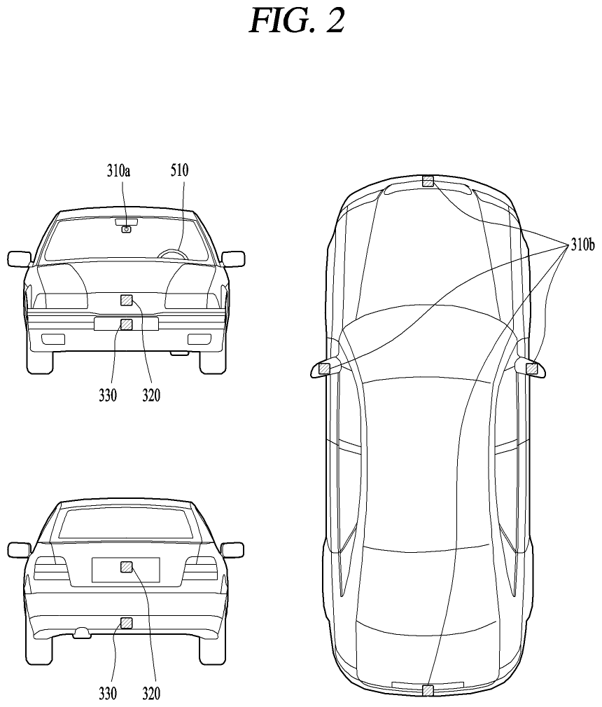

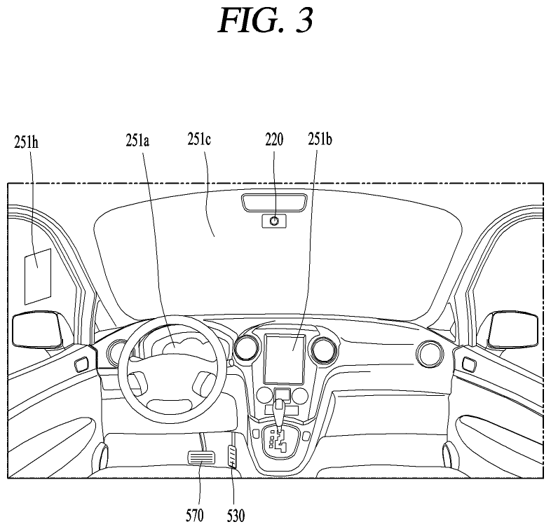

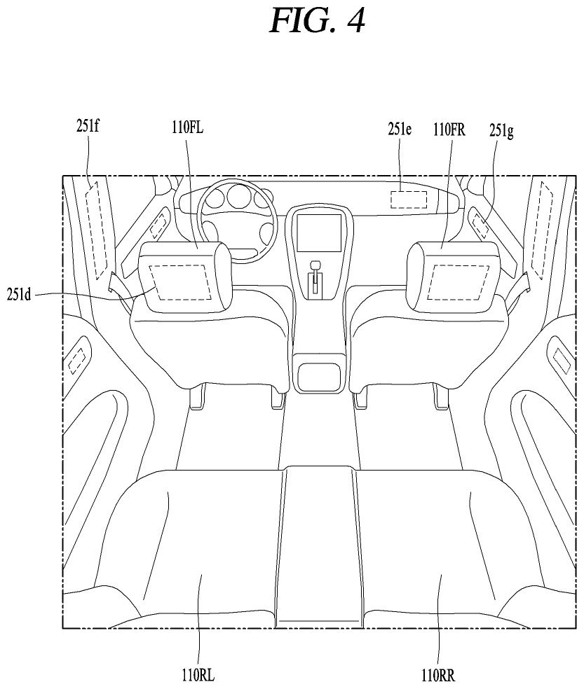

FIGS. 1 and 2 are views each illustrating the exterior of the vehicle in accordance with the embodiment of the present disclosure. FIGS. 3 and 4 are views each illustrating the interior of the vehicle in accordance with the embodiment of the present disclosure.

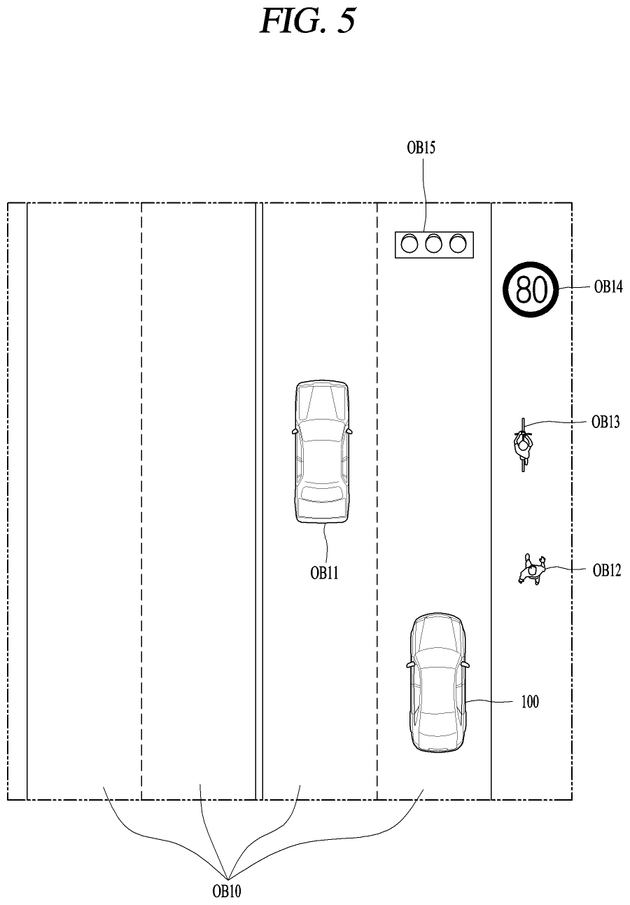

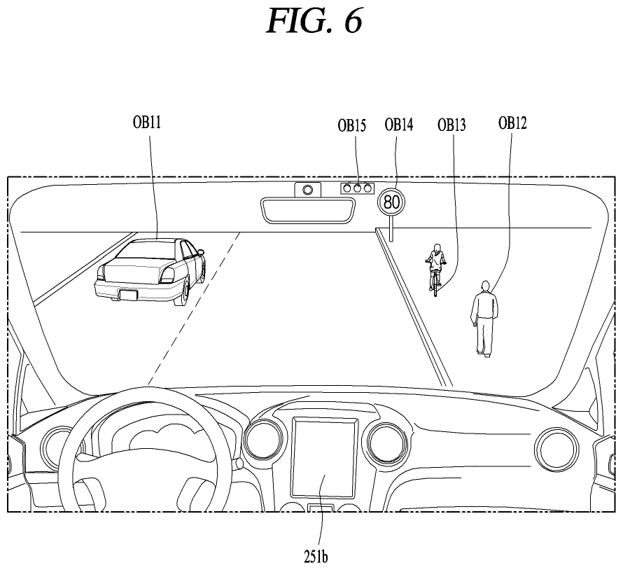

FIGS. 5 and 6 are views each illustrating various objects associated with vehicle driving in accordance with the embodiment of the present disclosure.

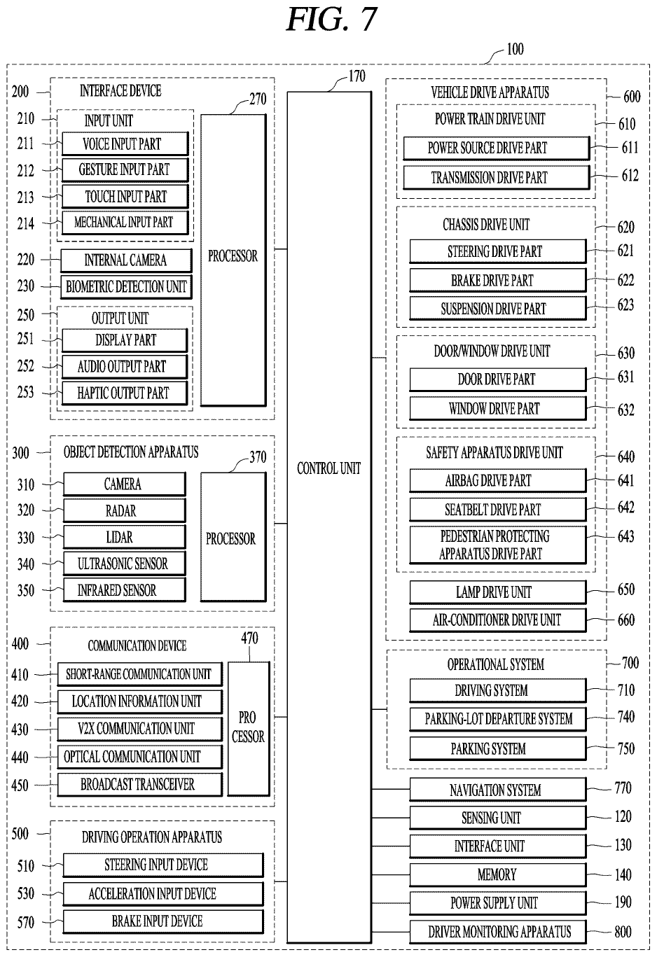

FIG. 7 is a block diagram that is referenced to describe the vehicle in accordance with the embodiment of the present disclosure. FIG. 7 is a block diagram that is referenced to describe the vehicle according to the embodiment of the present disclosure.

With reference to FIGS. 1 to 7, a vehicle 100 may include wheels that rotate by a power source and a steering input apparatus 510 for adjusting the driving direction of the vehicle 100.

The vehicle 100 may be an autonomous driving vehicle. The vehicle 100 may switch to an autonomous driving mode or a manual mode on the basis of a user input. For example, the vehicle 100 may switch from the manual mode to the autonomous driving mode or from the autonomous driving mode to the manual mode on the basis of a user input through a user interface device 200 (hereinafter referred to as a ‘user terminal’).

The vehicle 100 may switch to the autonomous driving mode or the manual mode on the basis of the driving situation information. The driving situation information may be generated on the basis of object information provided by an object detection device 300. For example, the vehicle 100 may switch from the manual mode to the autonomous driving mode or from the autonomous driving mode to the manual mode on the basis of the driving situation information generated by the object detection device 300. For example, the vehicle 100 may switch from the manual mode to the autonomous driving mode or from the autonomous driving mode to the manual mode on the basis of the driving situation information through a communication device 400.

The vehicle 100 may switch from the manual mode into the autonomous driving mode or from the autonomous driving mode to the manual mode on the basis of information, data, signals, all of which are provided by an external device.

In a case where the vehicle 100 may be driven in the autonomous driving mode, this autonomous driving vehicle 100 may be driven through the use of an operational system 700. For example, the autonomous driving vehicle 100 may be driven on the basis of information, data, and signals, all of which are generated by a driving system 710, a parking-lot departure system 740, and a parking system 750.

When the vehicle 100 is driven in the manual mode, the vehicle 100 may receive the user input for driving through a driving operation apparatus 500. The vehicle 100 may be driven on the basis of the user input received through the driving operation apparatus 500.

The overall length refers to the length from the front end to the rear end of the vehicle 100, the width refers to the width of the vehicle 100, and the height refers to the length from the bottom of the wheel to the roof. In the following description, an overall-length direction L may refer to a direction which serves as a reference for measuring the overall length of the vehicle 100, a width direction W may refer to a direction that serves as a reference for measuring the width of the vehicle 100, and a height direction H may refer to a direction that serves as a reference for measuring the height of the vehicle 100.

As illustrated in FIG. 7, the vehicle 100 may include the user interface device (hereinafter referred to as the ‘user terminal’) 200, the object detection device 300, the communication device 400, the driving operation apparatus 500, a vehicle drive apparatus 600, an operational system 700, a navigation system 770, a sensing unit 120, a vehicular interface unit 130, a memory 140, a control unit 170 and a power supply unit 190.

According to an embodiment, the vehicle 100 may further include one or more constituent elements in addition to constituent elements described in the present specification or may omit one or more of the described constituent elements.

The user interface device 200 is a device for communication between the vehicle 100 and the user. The user interface device 200 may receive the user input and may provide information, generated by the vehicle 100, to the user. The vehicle 100 may implement a user interface (UI) or user experience (UX) through the user interface device (hereinafter referred to as the ‘user terminal’) 200.

The user interface device 200 may include an input unit 210, an internal camera 220, a biometric detection unit 230, an output unit 250, and a processor 270. According to an embodiment, the user interface device 200 may further include one or more constituent elements in addition to constituent elements described in the present specification or may omit one or more of the described constituent elements.

The input unit 210 serves to receive information, as input, from the user. Data collected in the input unit 210 may be analyzed by the processor 270 and processed into a user's control command.

The input unit 210 may be arranged inside the vehicle 100. For example, the input unit 210 may be arranged on one region of the steering wheel, one region of the instrument panel, one region of the seat, one region of each pillar, one region of the door, one region of the center console, one region of the headlining, one region of the sun visor, one region of the windshield, one region of the window, or one region of a similar location.

The input unit 210 may include a voice input part 211, a gesture input part 212, a touch input part 213, and a mechanical input part 214.

The voice input part 211 may convert a user's voice input into an electric signal. The electric signal, resulting from the conversion, may be provided to the processor 270 or the control unit 170. The voice input part 211 may include at least one microphone.

The gesture input part 212 may convert a user's gesture input into an electric signal. The electric signal, resulting from the conversion, may be provided to the processor 270 or the control unit 170.

The gesture input part 212 may include at least one of the following: an infrared sensor or an image sensor, each of which is for detecting the user's gesture input. According to an embodiment, the gesture input part 212 may detect a user's three-dimensional (3D) gesture input. To this end, the gesture input part 212 may include a light-emitting diode, which emits a plurality of infrared rays or a plurality of image sensors.

The gesture input part 212 may detect the user's 3D gesture input through a time-of-flight (TOF) method, a structured light method, or a disparity method.

The touch input part 213 may convert the user's touch input into an electric signal. The electric signal, resulting from the conversion, may be provided to the processor 270 or the control unit 170.

The touch input part 213 may include a touch sensor for detecting the user's touch input. According to an embodiment, the touch input part 213 may be integrally formed with a display part 251, thereby implementing a touch screen. This touch screen may provide both an input interface and an output interface between the vehicle 100 and the user.

The mechanical input part 214 may include at least one of the following: a button, a dome switch, a jog wheel, or a jog switch. An electric signal generated by the mechanical input part 214 may be provided to the processor 270 or the control unit 170. The mechanical input part 214 may be arranged on a steering wheel, a center fascia, a center console, a cockpit module, a door, and the like.

The internal camera 220 may acquire an image of the interior of the vehicle 100. The processor 270 may detect a user's state on the basis of the image of the interior of the vehicle 100. The processor 270 may acquire the user's gaze information from the image of the interior of the vehicle 100. The processor 270 may detect the user's gesture from the image of the interior of the vehicle 100.

The biometric detection unit 230 may acquire the user's biometric information. The biometric detection unit 230 may include a sensor for acquiring the user's biometric information and may acquire the user's fingerprint information, heart rate information, and the like using the sensor. The biometric information may be used for user authentication.

The output unit 250 may generate an output associated with sight, hearing, or touch. The output unit 250 may include at least one of the following: the display part 251, an audio output part 252, or a haptic output part 253.

The display part 251 may output graphic objects corresponding to various types of information. The display part 251 may include at least one of the following: a liquid crystal display (LCD), a thin-film transistor-LCD (TFT LCD), an organic light-emitting diode (OLED), a flexible display, a three-dimensional (3D) display, or an e-ink display.

The display part 251 may be inter-layered with, or integrally formed with, the touch input part 213, thereby implementing a touch screen.

The display part 251 may be implemented as a head-up display (HUD). In a case where the display part 251 may be implemented as the HUD, the display part 251 may be equipped with a projection module and thus may output information through an image that is projected onto a window shield or a window.

An example of the display part 251 may be a transparent display. The transparent display may be attached to the windshield or the window. The transparent display may have a predetermined degree of transparency and may output a predetermined screen thereon. The transparent display may include at least one of the following: a thin-film electroluminescent (TFEL), a transparent organic light-emitting diode (OLED), a transparent liquid crystal display (LCD), a transmissive transparent display, or a transparent light-emitting diode (LED) display. The transparent display may have adjustable transparency.

The user interface device 200 may include a plurality of display parts, for example, display parts 251a to 251g.

The display part 251 may be arranged on one region of the steering wheel, one region 521a, 251b, or 251e of the instrument panel, one region 251d of the seat, one region 251f of each pillar, one region 251g of the door, one region of the center console, one region of the headlining, or one region of the sun visor, or may be implemented on one region 251c of the windshield, or one region of the window.

The audio output part 252 converts an electric signal provided from the processor 270 or the control unit 170 into an audio signal and outputs the audio signal. To this end, the audio output part 252 may include at least one speaker.

The haptic output part 253 generates a tactile output. For example, the haptic output part 253 may operate to vibrate the steering wheel, the safety belt, and the seats 110FL, 110FR, 110RL, and 110RR, thereby enabling the user to recognize the vibration output.

The processor (hereinafter referred to as the ‘control unit’) 270 may control the overall operation of each unit of the user interface device 200. According to an embodiment, the user interface device 200 may include a plurality of processors 270 or may not include any processor 270.

In a case where the processor 270 is not included in the user interface device 200, the user interface device 200 may operate under the control of a processor of another apparatus within the vehicle 100 or under the control of the control unit 170.

The user interface device 200 may be referred to as a vehicular display apparatus. The user interface device 200 may operate under the control of the control unit 170.

The object detection device 300 is a device for detecting an object located outside the vehicle 100. Examples of the object may include a variety of things associated with the driving of the vehicle 100. With reference to FIGS. 5 and 6, examples of an object O may include a traffic lane OB10, a different vehicle OB11, a pedestrian OB12, a two-wheeled vehicle OB13, traffic signals OB14 and OB15, ambient light, a road, a structure, a speed bump, a terrain feature, an animal, and the like.

The lane OB10 may be a driving lane, a lane adjacent to the driving lane, or a lane along which another vehicle in the opposite direction drives. The lane OB10 may conceptually include the left and right boundary lines forming a lane.

The different vehicle OB11 may be a vehicle that drives in the vicinity of the vehicle 100. The different vehicle OB11 may be a vehicle located within a predetermined distance from the vehicle 100. For example, the different vehicle OB11 may be a vehicle that drives ahead of or behind the vehicle 100. The pedestrian OB12 may be a person located in the vicinity of the vehicle 100. The pedestrian OB12 may be a person located within a predetermined distance from the vehicle 100. For example, the pedestrian OB12 may be a person located on a sidewalk or roadway.

The two-wheeled vehicle OB12 may be a person-carrying vehicle that is located in the vicinity of the vehicle 100 and moves on two wheels. The two-wheeled vehicle OB12 may be a person-carrying vehicle that is located within a predetermined distance from the vehicle 100 and has two wheels. For example, the two-wheeled vehicle OB13 may be a motorcycle or a bicycle that is located on a sidewalk or roadway.

Examples of the traffic signal may include a traffic light OB15, a traffic sign OB14, and a pattern or text drawn on a road surface.

The ambient light may be light generated from a lamp provided on another vehicle. The ambient light may be light generated from a street lamp. The ambient light may be solar light.

Examples of the road may include a road surface, a curve, an upward slope, a downward slope, and the like.

The structure may be an object that is located in the vicinity of a road and fixed on the ground. Examples of the structure may include a streetlamp, a roadside tree, a building, an electric pole, a traffic light, a bridge, and the like.

Examples of the terrain feature may include a mountain, a hill, and the like.

Objects may be classified into movable objects and stationary objects. Examples of the movable object may conceptually include another vehicle and a pedestrian. Examples of the stationary object may include a traffic signal, a road, and a structure.

Examples of the object detection device 300 may include a camera 310, a radar 320, a LIDAR 330, an ultrasonic sensor 340, an infrared sensor 350, and a processor 370.

According to an embodiment, the object detection device 300 may further include one or more constituent elements in addition to constituent elements described in the present specification or may omit one or more of the described constituent elements.

The camera 310 may be located in an appropriate portion of the exterior of the vehicle to acquire an image of the surroundings of the vehicle 100. The camera 310 may be a mono camera, a stereo camera 310a, an Around View Monitoring (AVM) camera 310b, or a 360-degree camera.

For example, the camera 310 may be arranged adjacent to a front windshield within the vehicle 100 to acquire an image of the surroundings in front of the vehicle 100. Alternatively, the camera 310 may be arranged in the vicinity of the front bumper or the radiator grill.

For example, the camera 310 may be arranged adjacent to a rear glass pane within the vehicle 100 to acquire an image of the surroundings behind the vehicle 100. Alternatively, the camera 310 may be arranged adjacent to the rear bumper, the trunk, or the tailgate.

For example, the camera 310 may be arranged adjacent to at least one of the side windows within the vehicle 100 to acquire an image of the surroundings alongside the vehicle 100. Alternatively, the camera 310 may be arranged in the vicinity of the side mirror, the fender, or the door.

The camera 310 may provide an acquired image to the processor 370.

The radar 320 may include an electromagnetic wave transmission unit and an electromagnetic wave reception unit. The radar 320 may be implemented in compliance with a pulse radar scheme or a continuous wave radar scheme according to the principle of emitting a radio wave. The radar 320 may be implemented in compliance with a Frequency Modulated Continuous Wave (FMCW) scheme or a Frequency Shift Keying (FSK) scheme, each of which is among continuous wave radar schemes, according to a signal waveform.

The radar 320 may detect an object using a time-of-flight (TOF) technique or a phase-shift technique, with an electromagnetic wave as a medium, and may detect a location of the detected object, a distance to the detected object, and a relative speed with respect to the detected object.

The radar 320 may be arranged in an appropriate position on the exterior of the vehicle 100 to detect an object that is located in front of, behind, or alongside the vehicle 100.

The LiDAR 330 may include a laser transmission unit and a laser reception unit. The LiDAR 330 may be implemented using a time-of-flight (TOF) technique or a phase-shift technique.

The LiDAR 330 may be implemented as a drive-type or non-drive-type LiDAR.

In a case where the LiDAR 330 may be implemented as a drive-type LIDAR, the LiDAR 330 may be rotated by a motor and may detect an object in the vicinity of the vehicle 100.

In a case where the LiDAR 330 may be implemented as a non-drive-type LiDAR, the LiDAR 330 may detect, through light steering, an object located within a predetermined range of the vehicle 100. The vehicle 100 may include a plurality of non-drive-type LiDARs 330.

The LiDAR 330 may detect an object using a time-of-flight (TOF) technique or a phase-shift technique, with laser light as a medium, and may detect a location of the detected object, a distance to the detected object, and a relative speed with respect to the detected object.

The radar 330 may be arranged in an appropriate position on the exterior of the vehicle 100 to detect an object that is located in front of, behind, or alongside the vehicle 100.

The ultrasonic sensor 340 may include an ultrasonic wave transmission unit and an ultrasonic wave reception unit. The ultrasonic sensor 340 may detect an object using an ultrasonic wave and may detect a position of the detected object, a distance to the detected object, and a relative speed with respect to the detected object.

The ultrasonic sensor 340 may be arranged in an appropriate position on the exterior of the vehicle 100 to detect an object located in front of, behind, or alongside the vehicle 100.

The infrared sensor 350 may include an infrared ray transmission unit and an infrared ray reception unit. The infrared sensor 340 may detect an object on the basis of infrared light, and may detect a location of the detected object, a distance from the detected object, and a relative speed with the detected object.

The infrared sensor 350 may be arranged in an appropriate position on the exterior of the vehicle 100 to detect an object located in front of, behind, or alongside the vehicle 100.

The processor 370 may control the overall operation of each unit of the object detection device 300.

The processor 370 may detect an object on the basis of an acquired image and may track the object. The processor 370 may perform operations, such as calculation of a distance to an object and calculation of a relative speed with respect to the object, through an image processing algorithm.

The processor 370 may detect an object on the basis of a reflected electromagnetic wave, resulting from an emitted electromagnetic wave being reflected off the object, and may track the object. The processor 370 may perform operations, such as calculation of a distance to the object and calculation of a relative speed with respect to the object, on the basis of the electromagnetic wave.

The processor 370 may detect an object on the basis of a reflected laser beam, resulting from an emitted laser being reflected off the object, and may track the object. The processor 370 may perform operations, such as calculation of a distance to the object and calculation of a relative speed with respect to the object, on the basis of the laser beam.

The processor 370 may detect an object on the basis of a reflected ultrasonic wave, resulting from an emitted ultrasonic wave being reflected off the object, and may track the object. The processor 370 may perform operations, such as calculation of a distance to the object and calculation of a relative speed with respect to the object, on the basis of the ultrasonic wave.

The processor 370 may detect an object on the basis of reflected infrared light, resulting from emitted infrared light being reflected off the object, and may track the object. The processor 370 may perform operations, such as calculation of a distance to the object and calculation of a relative speed with respect to the object, on the basis of the infrared light.

According to an embodiment, the object detection device 300 may include a plurality of processors 370 or may not include any processor 370. For example, each of the following: the camera 310, the radar 320, the LiDAR 330, the ultrasonic sensor 340, and the infrared sensor 350 may include its processor individually.

In a case where the processor 370 is not included in the object detection device 300, the object detection device 300 may operate under the control of a processor of an apparatus within the vehicle 100 or under the control of the control unit 170.

The object detection device 300 may operate under the control of the control unit 170.

The communication device 400 is a device for performing communication with an external device. The external device here may be another vehicle, a mobile terminal, or a server.

To perform communication, the communication device 400 may include a transmission antenna, a reception antenna, and at least one of the following: a radio frequency (RF) circuit or an RF device, each of which is capable of implementing various communication protocols.

The communication device 400 may include a short-range communication unit 410, a location information unit 420, a V2X communication unit 430, an optical communication unit 440, a broadcast transceiver 450, and a processor 470.

According to an embodiment, the communication device 400 may further include one or more constituent elements in addition to constituent elements in the present specification or may omit one or more of the described constituent elements.

The short-range communication unit 410 is a unit for short-range communication. The short-range communication unit 410 may support short-range communication using at least one of the following technologies: Bluetooth™, Radio Frequency IDentification (RFID), Infrared Data Association (IrDA), Ultra-Wide Band (UWB), Zig Bee, Near Field Communication (NFC), Wireless-Fidelity (Wi-Fi), Wi-Fi Direct, or Wireless Universal Serial Bus (USB).

The short-range communication unit 410 may form short-range wireless area networks and may perform short-range communication between the vehicle 100 and at least one external device.

The location information unit 420 is a unit for acquiring location information of the vehicle 100. For example, the location information unit 420 may include a Global Positioning System (GPS) module or a Differential Global Positioning System (DGPS) module.

The V2X communication unit 430 is a unit for performing wireless communications with a server (Vehicle to Infrastructure, V2I), another vehicle (Vehicle to Vehicle, V2V), or a pedestrian (Vehicle to Pedestrian, V2P). The V2X communication unit 430 may include an RF circuit capable of implementing protocols for communication with an infrastructure (V2I), communication between vehicles (V2V), and communication with a pedestrian (V2P).

The optical communication unit 440 is a unit for performing communication with an external device, with light as a medium. The optical communication unit 440 may include an optical transmission part for converting an electric signal into an optical signal and transmitting the optical signal to the outside, and an optical reception part for converting the received optical signal back into an electric signal.

According to an embodiment, the optical transmission part may be formed integrally with a lamp provided on the vehicle 100.

The broadcast transceiver 450 is a unit for receiving a broadcast signal from an external broadcast management server or transmitting a broadcast signal to the broadcast management server over a broadcast channel. The broadcast channel may include a satellite channel, a terrestrial channel, or both. The broadcast signal may include a TV broadcast signal, a radio broadcast signal, and a data broadcast signal.

The processor 470 may control the overall operation of each unit of the communication device 400.

According to an embodiment, the communication device 400 may include a plurality of processors 470 or may not include any processor 470.

In a case where the processor 470 is not included in the communication device 400, the communication device 400 may operate under the control of a processor of another device within the vehicle 100 or under the control of the control unit 170.

The communication device 400, along with the user interface device 200, may implement a vehicular display device. In this case, the vehicular display device may be referred to as a telematics device or an Audio Video Navigation (AVN) device.

The communication device 400 may operate under the control of the control unit 170.

The driving operation apparatus 500 is an apparatus for receiving a user input for driving.

In the manual mode, the vehicle 100 may be driven on the basis of a signal provided by the driving operation apparatus 500.

The driving operation apparatus 500 may include the steering input device 510, an acceleration input device 530, and a brake input device 570.

The steering input apparatus 510 may receive an input regarding the driving direction of the vehicle 100 from the user. The steering input apparatus 510 is preferably configured in the form of a wheel, allowing a steering input by the wheel's rotation. According to an embodiment, the steering input apparatus may also be configured in the shape of a touch screen, a touchpad, or a button.

The acceleration input apparatus 530 may receive an input for accelerating the vehicle 100 from the user. The brake input apparatus 570 may receive an input for decelerating the vehicle 100 from the user. The acceleration input apparatus 530 and the brake input apparatus 570 are preferably configured in the shape of a pedal. According to an embodiment, the acceleration input apparatus or the brake input apparatus may also be configured in the shape of a touch screen, a touchpad, or a button.

The driving operation apparatus 500 may operate under the control of the control unit 170.

The vehicle drive apparatus 600 is an apparatus that electrically controls driving of the various apparatuses within the vehicle 100.

The vehicle drive apparatus 600 may include a power train drive unit 610, a chassis drive unit 620, a door/window drive unit 630, a safety apparatus drive unit 640, a lamp drive unit 650, and an air-conditioner drive unit 660.

According to an embodiment, the vehicle drive apparatus 600 may further include one or more constituent elements in addition to constituent elements in the present specification or may omit one or more of the described constituent elements.

The vehicle drive apparatus 600 may include a processor. Each unit of the vehicle drive apparatus 600 may individually include its processor.

The power train drive unit 610 may control the operation of a power train apparatus.

The power train drive unit 610 may include a power source drive part 611 and a transmission drive part 612.

The power source drive part 611 may execute control on the power source of the vehicle 100.

For example, in a case where the power source of the vehicle 100 is a fossil fuel-based engine, the power source drive part 611 may execute electronic control on the engine. Accordingly, the output torque and other parameters of the engine may be controlled. The power source drive part 611 may adjust the engine output torque under the control of the control unit 170.

For example, in a case where the power source of the vehicle 100 is an electric energy-based motor, the power source drive part 611 may execute control on the motor. The power source drive part 611 may adjust a rotational speed, torque, and other parameters of the motor under the control of the control unit 170.

The transmission drive part 612 may execute control on a transmission. The transmission drive gearbox part 612 may adjust the state of the transmission. The transmission drive part 612 may change the state of the transmission to Drive (D), Reverse (R), Neutral (N), or Park (P).

In a case where the power source of the vehicle 100 is an engine, the transmission drive part 612 may adjust the engaged state of a gear in Drive (D).

The chassis drive unit 620 may control the operation of a chassis apparatus. The chassis drive unit 620 may include a steering drive part 621, a brake drive part 622, and a suspension drive part 623.

The steering drive part 621 may execute electronic control on a steering apparatus within the vehicle 100. The steering drive part 621 may change the driving direction of the vehicle 100.

The brake drive part 622 may execute electronic control on a brake apparatus within the vehicle 100. For example, the brake drive part 622 may reduce the speed of the vehicle 100 by controlling the operation of the brakes provided on the wheels.

The brake drive part 622 may individually control each of the brakes. The brake drive part 622 may control braking forces applied to the wheels so that they differ from one another.

The suspension drive part 623 may execute electronic control on a suspension apparatus within the vehicle 100. For example, in a case where a road surface is uneven, the suspension drive part 623 may reduce vibration of the vehicle 100 by controlling the suspension apparatus. The suspension drive part 623 may individually control each of the plurality of suspensions.

The door/window drive unit 630 may execute electronic control on a door apparatus or a window apparatus within the vehicle 100.

The door/window drive unit 630 may include a door drive part 631 and a window drive part 632.

The door drive part 631 may execute control on the door apparatus. The door drive part 631 may control the opening or closing of the plurality of doors included in the vehicle 100. The door drive part 631 may control the opening or closing of the trunk or the tailgate. The door drive part 631 may control the opening or closing of the sunroof.

The window drive part 632 may execute electronic control on the window apparatus. The window drive part 632 may control the opening or closing of the plurality of windows included in the vehicle 100.

The safety apparatus drive unit 640 may execute electronic control on the various safety apparatuses within the vehicle 100.

The safety apparatus drive unit 640 may include an airbag drive part 641, a seatbelt drive part 642, and a pedestrian protection apparatus drive part 643.

The airbag drive part 641 may execute electronic control on the airbag apparatus within the vehicle 100. For example, when a risk is detected, the airbag drive part 641 may control the airbag to deploy.

The seatbelt drive part 642 may execute electronic control on the seatbelt apparatus within the vehicle 100. For example, when a risk is detected, the seatbelt drive part 642 may secure the occupants in seats 110FL, 110FR, 110RL, and 110RR by tightening seat belts.

The pedestrian protection apparatus drive part 643 may execute electronic control on the hood lift and the pedestrian airbag. For example, when a collision with a pedestrian is detected, the pedestrian protection apparatus drive part 643 may control the hood lift and the pedestrian airbag to deploy.

The lamp drive part 650 may execute electronic control on the various lamp apparatuses within the vehicle 100.

The air-conditioner drive unit 660 may execute electronic control on the air conditioner within the vehicle 100. For example, when the temperature inside the vehicle 100 is high, the air-conditioner drive unit 660 may control the air conditioner to operate in such a manner as to supply cool air into the vehicle 100.

The vehicle drive apparatus 600 may include a processor. Each unit of the vehicle drive apparatus 600 may individually include its processor.

The vehicle drive apparatus 600 may operate under the control of the control unit 170.

The operational system 700 is a system that controls various driving functions of the vehicle 100. The operational system 700 may operate in the autonomous driving mode.

The operational system 700 may include the driving system 710, the parking-lot departure system 740, and the parking system 750.

According to an embodiment, the operational system 700 may further include one or more constituent elements in addition to constituent elements described in the present disclosure or may emit one or more of the described constituent elements.

The operational system 700 may include a processor. Each unit of the operational system 700 may individually include its processor.

According to an embodiment, in a case where the operational system 700 may be implemented in software, the operational system 700 may also conceptually operate at a lower level than the control unit 170.

According to an embodiment, the operational system 700 may conceptually include at least one of the following: the user interface device 200, the object detection device 300, the communication device 400, the vehicle drive apparatus 600, or the control unit 170.

The driving system 710 may enable the vehicle 100 to drive.

The driving system 710 may receive navigation information from a navigation system 770, may provide a control signal to the vehicle drive apparatus 600, and may enable the vehicle 100 to drive. The driving system 710 may receive object information from the object detection device 300, may provide a control signal to the vehicle drive apparatus 600, and may enable the vehicle 100 to drive. The driving system 710 may receive a signal from an external device through the communication device 400, may provide a control signal to the vehicle drive apparatus 600, and may enable the vehicle 100 to drive.

The parking-lot departure system 740 may perform a departure maneuver for the vehicle 100.

The parking-lot departure system 740 may receive navigation information from the navigation system 770, may provide a control signal to the vehicle drive apparatus 600, and may perform a departure maneuver for the vehicle 100. The parking-lot departure system 740 may receive object information from the object detection device 300, may provide a control signal to the vehicle drive apparatus 600, and may perform a departure maneuver for the vehicle 100. The parking-lot departure system 740 may receive a signal from an external device through the communication device 400, may provide a control signal to the vehicle drive apparatus 600, and may perform a departure maneuver for the vehicle 100.

The parking system 750 may perform a parking maneuver for the vehicle 100.

The parking system 750 may receive navigation information from the navigation system 770, may provide a control signal to the vehicle drive apparatus 600, and may perform a parking maneuver for the vehicle 100. The parking system 750 may receive object information from the object detection device 300, may provide a control signal to the vehicle drive apparatus 600, and may perform a parking maneuver for the vehicle 100. The parking system 750 may receive a signal from an external device through the communication device 400, may provide a control signal to the vehicle drive apparatus 600, and may perform a parking maneuver for the vehicle 100.

The navigation system 770 may provide navigation information. The navigation information may include at least one of the following: map information, set-destination information, path information based on the set destination, information about various objects on a path, lane information, or current vehicular location information.

The navigation system 770 may include a memory and a processor. The navigation information may be stored in the memory. The processor may control the operation of the navigation system 770.

According to an embodiment, the navigation system 770 may update pre-stored information by receiving information from an external device through the communication device 400.

According to an embodiment, the navigation system 770 may also be classified as a sub-constituent element of the user interface device 200.

The sensing unit 120 may sense the state of the vehicle 100. The sensing unit 120 may include a posture sensor (e.g., a yaw sensor, a roll sensor, a pitch sensor, or the like), a collision sensor, a wheel sensor, a speed sensor, a tilt sensor, a weight-detection sensor, a heading sensor, a gyro sensor, a position module, a vehicle forward/backward movement sensor, a battery sensor, a fuel sensor, a tire sensor, a steering sensor sensing the turning of a steering wheel, an in-vehicle temperature sensor, an in-vehicle humidity sensor, an ultrasonic sensor, an illumination sensor, an accelerator position sensor, a brake pedal position sensor, and other sensors.

The sensing unit 120 may acquire vehicular posture information, vehicular collision information, vehicular direction information, vehicular location information (GPS information), vehicular angle information, vehicular speed information, vehicular acceleration information, vehicular tilt information, vehicular forward/backward movement information, battery information, fuel information, tire information, vehicular lamp information, in-vehicle temperature information, and in-vehicle humidity information. Furthermore, the sensing unit 120 may acquire signals that result from sensing a steering wheel rotation angle, outside-vehicle illumination, pressure applied to an acceleration pedal, pressure applied to a brake pedal, and the like.

The sensing unit 120 may further include an acceleration pedal sensor, a pressure sensor, an engine speed sensor, an air flow sensor (AFS), an air temperature sensor (ATS), a water temperature sensor (WTS), a throttle position sensor (TPS), a TDC sensor, a crank angle sensor (CAS), and other sensors. The vehicular interface unit 130 may serve as a path to various types of external devices connected to the vehicle 100. For example, the vehicular interface unit 130 may include a port that enables a connection with a mobile terminal and may be connected to the mobile terminal through the port. In this case, the vehicular interface unit 130 may exchange data with the mobile terminal.

The vehicular interface unit 130 may serve as a path for supplying electric energy to the connected mobile terminal. In a case where the mobile terminal is electrically connected to the vehicular interface unit 130, the vehicular interface unit 130 may supply electric energy, supplied from the power supply unit 190, to the mobile terminal under the control of the control unit 170.

The memory 140 is electrically connected to the control unit 170. Basic data for the units, control data for controlling operations of the units, and data, which are input and output, may be stored in the memory 140. Examples of the memory 140 may include various hardware storage devices, such as a ROM, a RAM, an EPROM, a flash drive, and a hard drive. Programs for processing or control by the control unit 170, and various data for the overall operation of the vehicle 100 may be stored in the memory 140.

According to an embodiment, the memory 140 may be configured to be integrated with the control unit 170 or may be implemented as a sub-constituent element of the control unit 170.

The control unit 170 may control the overall operation of each unit within the vehicle 100. The control unit 170 may be referred to as an Electronic Control Unit (ECU).

The power supply unit 190 may supply power necessary for the operation of each constituent element under the control of the control unit 170. Specifically, the power supply unit 190 may receive power supplied from the battery inside the vehicle 100, or from other sources.

At least one processor and the control unit 170, which are included in the vehicle 100, may be implemented using at least one of the following: application-specific integrated circuits (ASICs), digital signal processors (DSPs), digital signal processing devices (DSPDs), programmable logic devices (PLDs), field-programmable gate arrays (FPGAs), processors, controllers, microcontrollers, microprocessors, or electric units performing other functions.

In embodiments of the present disclosure, the terms ‘driver,’ ‘occupant,’ ‘driver or occupant (driver/occupant)’ are collectively used to refer to one or more persons, such as a driver, a passenger, a fellow passenger, and an occupant, who ride in a vehicle that is capable of autonomous driving according to an embodiment of the present disclosure.

In addition, in the embodiments of the present disclosure, the term ‘vehicle’ is used to refer to a vehicle capable of autonomous driving by means of artificial intelligence (AI) or to a vehicle configured to receive autonomous driving functionality as a service. Additionally, in the embodiments of the present disclosure, the term ‘vehicle’ is used to refer to a vehicle capable of switching between manual driving by the driver, semi-autonomous driving, and full self-driving.

In the embodiments of the present disclosure, a ‘driving mode display device’ may display a graphic object and driving-related information through at least one of a cluster, a center information display (CID), a head-up display (HUD), or a multi-screen within a vehicle. The graphic object may indicate an autonomous driving mode or a manual driving mode of the vehicle in a manner that can be intuitively recognized by the occupant. To this end, the ‘driving mode display device’ may communicate with an advanced driver assistance system (ADAS), an autonomous driving system (ADS), and/or a full self-driving (FSD), each of which is installed within the vehicle, and with an external system, apparatus, or server that is capable of providing the corresponding service.

FIG. 7 is a block diagram that is referenced to describe a driving mode display device 800 for a vehicle, according to an embodiment of the present disclosure.

As illustrated in FIG. 7, the driving mode display device 800 according to an embodiment of the present disclosure may be provided within a vehicle 100.

The driving mode display device 800 may receive, through a communication module, sensing values and control values from various sensors within the vehicle and various apparatuses or systems within the vehicle, such as an advanced driver assistance system (ADAS) and a driver monitoring system (DMS). These sensors and apparatuses or systems are associated with a driving operation.

The driving mode display device 800 may detect whether the vehicle's driving mode is a manual driving mode or an autonomous driving mode, and may configure a corresponding driving mode screen.

Specifically, the driving mode display device 800 may be configured to differentiate between screens for the autonomous driving mode and the manual driving mode for the vehicle, such that the occupant can intuitively recognize the driving mode. In the autonomous driving mode, the driving mode display device 800 may display a virtual steering wheel. When the autonomous driving mode is switched to the manual driving mode, the driving mode display device 800 may operate such that the virtual steering wheel is no longer displayed. Accordingly, the vehicle occupant can intuitively recognize a switch in the driving mode.

The driving mode display device 800 may display a driving mode screen and/or a virtual steering wheel through various displays within the vehicle. For example, the driving mode display device 800 may display the driving mode screen through at least one of the following: the cluster, the head-up display (HUD), the center information display (CID), or the multi-screen within the vehicle 100.

Specifically, the driving mode display device 800 may receive the vehicle's map data. Alternatively, the driving mode display device 800 may display the driving mode screen on a high-definition map (HD map) generated based on a digital twin configured on the vehicle's map data and other related data.

The digital twin is a virtual representation of a real-world environment, which may be rendered on a digital screen. The operation of the digital twin involves: collecting, in real time, driving-related data occurring in the real world; transmitting the collected data to a cloud-based platform for processing, storage, and modeling; performing prediction and simulation of real-world actions; and responding promptly to changes that occur in real time in the real world.

The high-definition map (HD map) may serve as a navigation map that supports the operation of artificial intelligence (AI) for autonomous driving. During autonomous driving of the vehicle, based on data obtained from the high-definition map (HD map), a sensor, such as a LiDAR, a radar, or a camera, recognizes the surrounding environment of the vehicle. The high-definition map (HD map) provides, with the three-dimensional precision, all information (e.g., the location, size, shape, and movement of surrounding objects, lane positions on the road, and the positions of traffic signals) necessary for the autonomously driving vehicle to avoid collisions with other vehicles, pedestrians, buildings, or similar stationary obstacles, thereby enhancing the performance and safety of autonomous driving.

The driving mode display device 800 provides not only information about the conditions of an object in the vicinity of the vehicle and the vehicle's travel path, but also information that enables the occupant to intuitively recognize the state of the autonomous driving mode, in order to minimize the vehicle occupant's uncertainty.

To this end, during the vehicle's activation of the autonomous driving mode, the driving mode display device 800 controls the virtual steering wheel to appear on at least one of the cluster, the head-up display (HUD), the center information display (CID), or other multi-screens within the vehicle 100.

The driving mode display device 800 may control the display such that the virtual steering wheel rotates in synchronization with actual steering changes during the autonomous driving of the vehicle. For example, when the vehicle changes the steering direction to the right to perform a lane change, the driving mode display device 800 may change a graphic image of the virtual steering wheel while displaying a travel path for the lane change, such that the virtual steering wheel is rotated in synchronization with the actual steering change.

The driving mode display device 800 may control the display of the result of detecting the degree of engagement of the autonomous driving mode on the virtual steering wheel. For example, the driving mode display device 800 may change the graphic image of the virtual steering wheel such that various colors are applied to the virtual steering wheel according to the degree of engagement of the autonomous driving mode.

In a case where a switch to the manual driving mode is required based on the detection of the degree of engagement of the autonomous driving mode and/or the surrounding environment of the vehicle, the driving mode display device 800 may control the display of the need for such switching, in conjunction with the display of the virtual steering wheel. For example, when the need for the switch to the manual driving mode is detected, the driving mode display device 800 may display a graphic object, providing guidance for switching to the manual driving mode, on the vicinity of the virtual steering wheel, and may display a highlighting effect, such as blinking, on the virtual steering wheel to attract the driver's attention.

The driving mode display device 800 according to the present disclosure may be a component of any one of the following systems: an advanced driver assistance system (ADAS), an autonomous driving system (ADS), or a full self-driving system (FSD) within the vehicle, or may be a component included therein.

In addition, the driving mode display device 800 may include a pre-trained driving model or may be configured to perform training of a driving model. At this point, the pre-trained driving model may refer to a driving model trained to perform autonomous driving techniques through machine learning, which is a subset of artificial intelligence (AI), reinforcement learning (e.g., deep reinforcement learning using deep learning technologies, reinforcement learning utilizing a simulator, and similar methods), end-to-end learning, or similar AI-based approaches. However, the pre-trained driving model may be trained using learning methods other than the above-described training methods. Data used in machine learning, which is a subset of artificial intelligence (AI), for autonomous driving of the vehicle 100, may include sensor values collected by various types of sensors installed in the vehicle 100. For example, the data used in machine learning, which is a subset of artificial intelligence (AI), for the vehicle's autonomous driving may include data obtained from a camera, radar, and LiDAR installed in the vehicle.

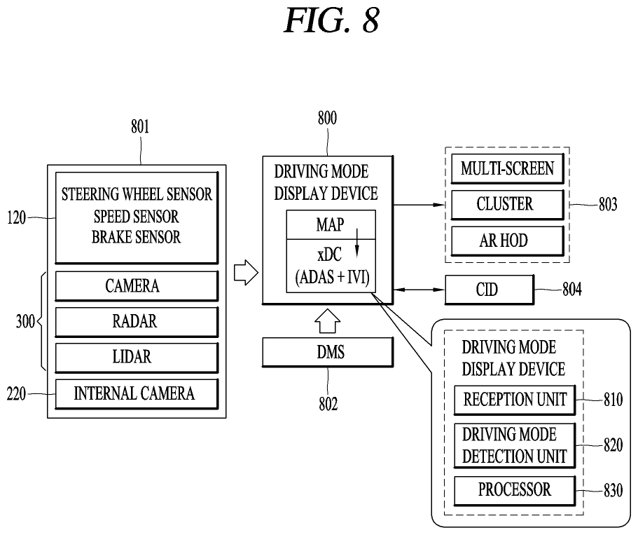

FIG. 8 is a block diagrams that is referenced to describe the detailed configuration of the driving mode display device 800 according to the embodiment of the present disclosure, and a related configuration of the vehicle.

The driving mode display device 800 may be configured to be embedded in the vehicle 100 as illustrated in FIG. 7, or may be configured as a stand-alone system separate from the vehicle 100.

In addition, the driving mode display device 800 may be configured in the form of a module or device. Examples of such a module or device include a single chip. Specifically, the driving mode display device 800 may execute a platform resulting from the integration of an advanced driver assistance system (ADAS) and an in-vehicle infotainment system (IVI). The driving mode display device 800 may be configured in the form of a single chip.

In addition, as described above, the driving mode display device 800 may also have a form that allows integration into other devices or systems within the vehicle.

The driving mode display device 800 may be configured to include a receiver 810, a driving mode detection unit 820, and a processor 830.

The receiver 810 receives a forward-facing image obtained through the vehicle's camera, the vehicle's map data, namely, the MAP, and various types of sensing information associated with the vehicle's autonomous driving. To this end, the receiving unit 810 may communicate with various sensors, devices, or systems through a vehicular service-oriented architecture (SOA) communication framework.

The driving mode detection unit 820 detects the vehicle's autonomous driving mode. Specifically, the driving mode detection unit 820 may recognize initiation or cancellation of the autonomous driving mode based on an input signal. In addition, the driving mode detection unit 820 may recognize whether the driving mode is a full autonomous driving mode or a semi-autonomous driving mode, and may detect in real time whether an engagement state of the autonomous driving mode is stable.

The driving mode detection unit 820 may recognize whether the autonomous driving mode is activated and the type of autonomous driving mode, by receiving an input signal from, for example, a center information display (CID). In addition, the driving mode detection unit 820 may recognize the engagement state of the autonomous driving mode on the basis of sensing information received from a plurality of autonomous driving sensors of the vehicle, for example, a camera, a radar, and a LiDAR, and sensing information collected through, for example, a body control module (BCM), a vehicle dynamic control (VDC), a steering wheel sensor, a speed sensor, and a brake sensor.

The processor 830 may generate the virtual steering wheel representing the vehicle's autonomous driving mode, and may control the display of the generated virtual steering wheel on the vehicle's forward-facing image (including the HUD for AR or MR). To this end, the processor 830 may include an AR or MR engine.

In addition, the processor 830 may include a single system-on-a-chip (SoC), a microcontroller unit (MCU), or the like that includes a hypervisor for vehicular software integration, a data processing device (CPU), an RT core, an AP core, an NPU, a GPU, and other similar components. In addition, the processor 830 may operate in conjunction with one or more AI-trained models and software for in-cabin sensing.

During driving of the vehicle 100, the processor 830 may recognize the vehicle's driving state on the basis of map data and various types of sensing information, and may then control the display of the recognized vehicle's driving state on the virtual steering wheel in a synchronized manner. For example, the processor 830 may control the display of the rotating image on the virtual steering wheel by synchronizing a steering angle change detected through the steering wheel sensor with the virtual steering wheel.

The driving mode display device 800 illustrated in FIG. 8 may receive the vehicle's map data or the HD map (hereinafter referred to as the ‘MAP’) to which a digital twin technology applies. In addition, the driving mode display device 800 may receive the forward-facing image collected in real time through the camera installed in the vehicle.

The driving mode display device 800 may be a module that includes a single chip capable of executing the platform resulting from the integration of the advanced driver assistance system (ADAS) and the in-vehicle infotainment system (IVI). At this point, the platform may be a platform that provides various information display services in accordance with the activation of the autonomous driving mode of the vehicle 100.

The driving mode display device 800 may detect the initiation or activation of the autonomous driving mode. For example, the driving mode display device 800 may recognize that the autonomous driving mode has been selected, through an input device within the vehicle, such as a center information display (CID) (804).

The driving mode display device 800 may receive various sensing values for autonomous driving from the plurality of autonomous driving sensors, for example, a camera, a radar, and a LIDAR. The driving mode display device 800 may display, on a display 803, driving situation information recognized on the basis of these sensing values in a manner that corresponds to the selected autonomous driving module.

At this point, the display 803 may include not only a display including a display module but also a region where an AR or MR object generated through an AR or MR engine is rendered. Specifically, the display 803 may refer to one or more of the following: a cluster, an AR HUD (or an MR HUD), a CID 804, or a multiscreen.

The driving mode display device 800 may display the virtual steering wheel on the display 803 based on the selection of the autonomous driving mode, and may also display a change in the driving state, the change being based on various sensors 801, either in synchronization with the virtual steering wheel or concurrently therewith.

Various sensors 801 may include vehicle driving-related sensors 120 that include the vehicle dynamic control (VDC) or the BCM device, the steering wheel sensor, the speed sensor, the brake sensor, and the like, the plurality of autonomous driving sensors that include a camera, a radar, a LiDAR, and the like, the internal camera 220 for in-cabin sensing, and the like.

At this point, the VDC device is a device that performs a function of enabling the vehicle to control engine torque and braking independently in response to hazardous situations. The operation of the VDC device requires a sensor that detects the rotation of the vehicle, a sensor that detects a steering angle, and a sensor that detects the rotation of each wheel of the vehicle. For example, in a case where understeering or oversteering occurs when the vehicle enters a corner, the VDS device collects sensor information, such as vehicle speed and steering angle, from the sensors and appropriately adjusts the distribution of force to the four wheels such that the vehicle returns to the intended position thereof, thereby controlling the vehicle.

The body control module (BCM) is a device resulting from the integration of a plurality of electronic control units (ECUs) used for various functions in the vehicle, and performs integrated control as a single central control device.

For example, the BCM is a device that performs integrated control of various ECU-controlled functions, such as a light control function, an escort headlamp function, a wiper control function, a seatbelt warning function, a door locking and unlocking function, and a power window timer function.

The driving mode display device 800 may use in-cabin sensing technology to determine whether the driver is capable of intervention or driving in a case where the driver's temporary intervention is required in the autonomous driving mode or in a case where the switch to the manual driving mode is required.

The in-cabin sensing technology detects a state of driver inattentiveness based on the driver's biometric signals (eye movement and facial expressions) acquired through the internal camera 220 without the vehicle. Based on this detection, a driver state warning system operates to provide an alarm and a warning.

When the driver's intervention or the switch to the manual driving mode is required, the driving mode display device 800 may determine whether the driver's state permits the driver's intervention or the switch to the manual driving mode, on the basis of the driver state information collected through the internal camera 220. This determination is made in conjunction with a driver monitoring system (DMS) 802.

In this manner, the driving mode display device 800 according to the present disclosure may allow the vehicle occupant to intuitively recognizes the autonomous driving mode currently being activated and may notify the vehicle occupant of how well the autonomous driving is being performed, through a synchronized visual image, thereby minimizing a sense of uncertainty and apprehension that may be experienced by the vehicle occupant during the autonomous driving of the vehicle.

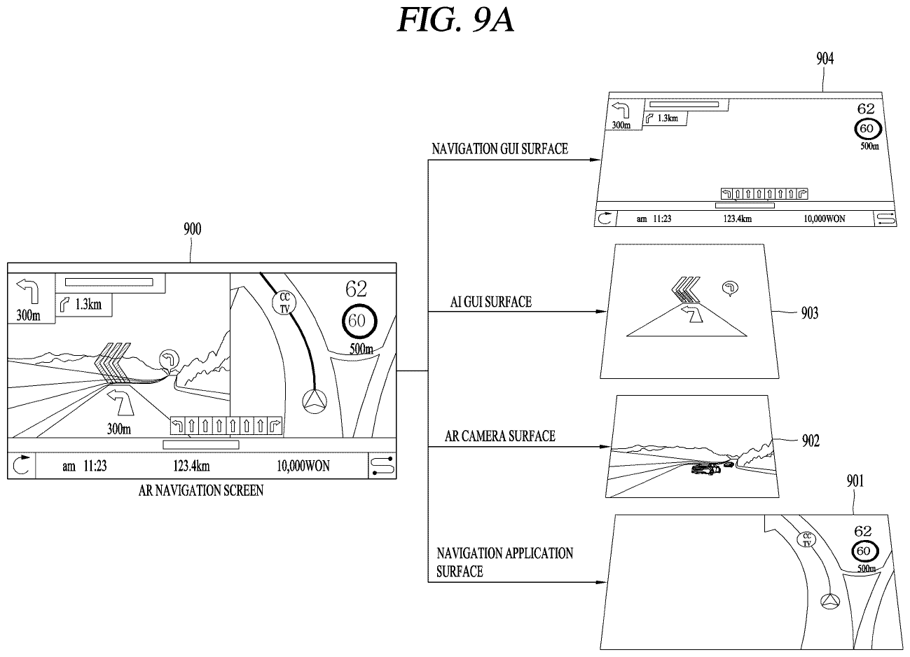

FIG. 9A is a set of views illustrating a navigation screen according to an embodiment of the present disclosure. FIG. 9B is a set of views that are referenced to describe an operation of generating a navigation screen.

The driving mode display device 800 according to the present disclosure may display a virtual steering wheel indicating that the autonomous driving mode is being activated, through the display within the vehicle 100, for example, through at least one of the following: the cluster, the AR HUD, the CID, or the multi-screen.

Specifically, the driving mode display device 800 may display the virtual steering wheel on an AR navigation screen corresponding to the forward-facing image of the vehicle, the image being illustrated in FIGS. 9A and 9B. To this end, a processor of the driving mode display device 800 may include an AR engine and may be configured to generate an AR navigation screen 900 through a navigation application.

With reference to FIG. 9A, the AR navigation screen 900 may include a navigation map surface 901, an AR camera surface 902, an AR GUI surface 903, and a navigation GUI surface 904.

For example, when the navigation application is executed, the navigation map surface 901, the AR camera surface 902, the AR GUI surface 903, and the navigation GUI surface 904 may be generated in the navigation application.

The navigation application may provide a parameter of the AR camera surface 902 and a parameter of the AR GUI surface 903 to the AR engine or the processor of the driving mode display device 800.

With reference to FIG. 9B, the AR engine or the processor of the driving mode display device 800 may register a callback function to receive forward-facing image data from a camera server 1001. The camera server 1001 may be conceptually understood as being implemented, for example, in the memory of the driving mode display device 800.

The AR engine or the processor of the driving mode display device 800 may receive and crop forward-facing image data. Cropping may include adjusting the size or position of an image, editing one region thereof, controlling the transparency thereof, and performing other similar operations. The navigation application may display the cropped forward-facing image on the AR camera surface 902. The AR engine or the processor of the driving mode display device 800 may perform AR merging in real time. In addition, the navigation application may display an AR GUI on the AR GUI surface 903 on the basis of the cropped forward-facing image.

The AR engine of the processor of the driving mode display device 800 may render a virtual steering wheel in a lower region of the cropped forward-facing image, the lower region corresponding to a steering wheel, during driving of the vehicle in the autonomous driving mode.

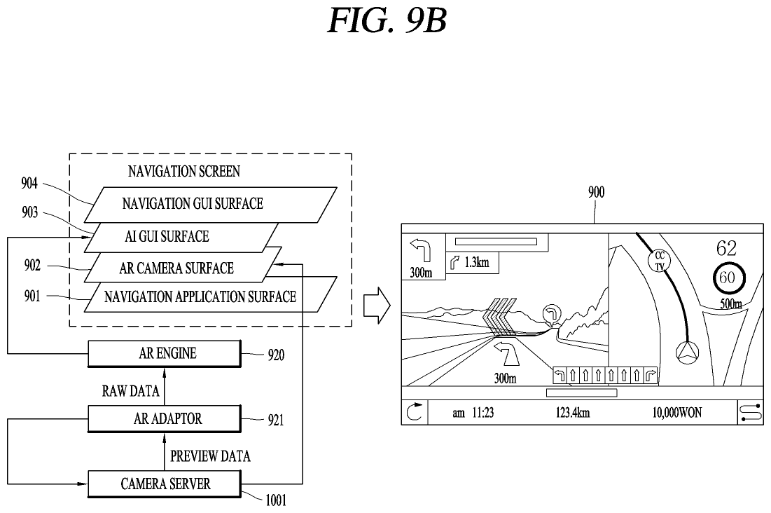

FIG. 10 is a representative flowchart that is referenced to describe a method of operating a vehicle, according to an embodiment of the present disclosure. Each step in FIG. 10, unless otherwise stated, is performed by the driving mode display device 800 or the processor 830 thereof (in FIG. 8).

With reference to FIG. 10, the driving mode display device 800 receives the forward-facing image acquired through the vehicle's camera, the vehicle's map data, and the vehicle's sensing information (S1010).

Specifically, the driving mode display device 800 may receive the forward-facing image through the vehicle's camera and the like and may receive the map data in such a manner that information, such as the vehicle's driving path and traffic situation, is recognizable. The driving mode display device 800 may generate an AR navigation screen on the basis of the received forward-facing image and map data. The AR navigation screen may display the vehicle's travel path.

In some embodiments, the driving mode display device 800 may detect the driver's entry into the vehicle and detect an auxiliary driving setting that matches the recognized driver level. In this case, the driving mode display device 800 may display, on the forward-facing image, a virtual graphic object that represents the driving situation detected on the basis of the vehicle's map data and sensing information, along with the virtual steering wheel, in accordance with the detected auxiliary driving setting.

At this point, the auxiliary driving setting appropriate to the driver level refers to a screen configuration of various auxiliary driving operations, the screen configuration being variously set on the basis of the driver's experience with autonomous driving. For example, when a driver with extensive autonomous driving experience is assigned a high driver level, the screen configuration may be set to be simpler than when the autonomous driving mode is activated. In addition, for example, when a driver unfamiliar with autonomous driving is assigned a low driver level, the screen configuration may be set to provide more detailed situation information than when the autonomous driving mode is activated.

In addition, the driving mode display device 800 may receive various types of sensing information associated with the vehicle driving, the vehicle's state, object detection, the driver's state, and other driving-related parameters.

To this end, the driving mode display device 800 may receive, for example, control information and/or sensing information acquired from devices or sensors 120, such as the vehicle dynamic control (VDC) or the body control module (BCM), the steering wheel sensor, the speed sensor, and the brake sensor, which are illustrated in FIG. 8.

In addition, the driving mode display device 800 may receive, for example, sensing information and/or situation information collected through object detection devices 300, such as a camera, a radar, and a LIDAR, which are illustrated in FIG. 8.

Additionally, the driving mode display device 800 may receive, for example, information about the driver's state monitored through the internal camera 220 within the vehicle, which is illustrated in FIG. 8.

Next, the driving mode display device 800 detects that the vehicle is being driven in the autonomous driving mode (S1020).

Specifically, the driving mode display device 800 may detect whether the vehicle is currently in the autonomous driving mode or the manual driving mode, based on the vehicle's driving mode selection signal. In addition, the driving mode display device 800 may detect whether the vehicle is in a fully autonomous driving mode or a semi-autonomous driving mode, which is a subset of the autonomous driving mode, based on the vehicle's driving mode selection signal.

To this end, in some embodiments, the driving mode display device 800 may receive an input for selecting one of a plurality of autonomous driving modes.

For example, the driving mode display device 800 may detect a signal corresponding to the autonomous driving mode selected through the center information display (CID) within the vehicle 100, and thus may recognize the autonomous driving mode that is to be activated by the vehicle 100. For example, the driving mode display device 800 may receive a signal corresponding to either a Level 2 (LV2) autonomous driving mode or a Level 3 (LV3) or higher autonomous driving mode. Each of these modes is selected through the CID. The driving mode display device 800 may recognize the selected autonomous driving mode on the basis of the received signal.

The driving mode display device 800 may display the virtual steering wheel representing the detected autonomous driving mode, on the vehicle's forward-facing image, based on the detection that the vehicle is being driven in the autonomous driving mode (S1030).

In this manner, the virtual steering wheel may be rendered and displayed on the vehicle's digital cluster screen, thereby minimizing a sense of uncertainty and apprehension that may be experienced by the driver during the autonomous driving of the vehicle and providing a sense of security that a vehicle system is operating properly.

At this point, the ‘virtual steering wheel representing the detected autonomous driving mode refers to a virtual steering wheel appropriate to the detected autonomous driving mode. That is, the driving mode display device 800 may display the virtual steering wheel with images differing in type, thereby enabling the driver to intuitively recognize the type of the autonomous driving mode that is detected as being active.

For example, in the fully autonomous driving mode, the driving mode display device 800 may display a first virtual steering wheel on the forward-facing image, thereby enabling the driver to intuitively recognize that the vehicle is being driven in the fully autonomous driving mode. Additionally, for example, in the semi-autonomous driving mode, the driving mode display device 800 may display a second virtual steering wheel on the forward-facing image, thereby enabling the driver to intuitively recognize that the vehicle is in the semi-autonomous driving mode. At this point, the first and second virtual steering wheels may have different transparency values, and the second virtual steering wheel may be configured to have a higher transparency value than the first virtual steering wheel. Accordingly, the driver can intuitively recognize, solely through the displayed virtual steering wheel, whether the vehicle is being driven in the fully autonomous mode or the semi-autonomous mode.

In addition to having different transparency values, the first and second virtual steering wheels may be displayed to have different colors or different shapes, or may be highlighted, thereby enabling the driver to intuitively recognize the fully autonomous mode and the semi-autonomous mode. Alternatively, objects or the like may be additionally displayed to provide explanations of the fully autonomous mode and the semi-autonomous mode.

The virtual steering wheel may be rendered and displayed on the forward-facing image at the position of the display (e.g., the cluster, the HUD, the CID, the window, the multi-screen, or the like), the position corresponding to the actual steering wheel in front of the driver's seat. In some embodiments, the virtual steering wheel may be displayed at a predetermined range of heights above the actual steering wheel and rendered such that the image thereof can be easily identified at a glance without being obscured by the physical steering wheel.

In some embodiments, the virtual steering wheel displayed on the forward-facing image may represent a portion of the circular physical steering wheel, for example, the upper half of the circular physical steering wheel.

In some embodiments, the virtual steering wheel displayed on the forward-facing image may be represented to indicate the engagement state of the autonomous driving mode. For example, the driving mode display device 800 may monitor the engagement state of the autonomous driving mode during activation of the autonomous driving mode. Accordingly, the driving mode display device 800 may control the display of the virtual steering wheel such that an image, color, or highlighting effect, indicating whether the engagement state of the autonomous driving mode is stable or unstable, is applied.

In some embodiments, when the engagement state of the autonomous driving mode is changed, the driving mode display device 800 may display the changed engagement state in a manner that is reflected in the virtual steering wheel. For example, in a case where the engagement state is stable, the virtual steering wheel may be displayed in green. Conversely, in a case where the connection is unstable and requires the driver's partial intervention, the virtual steering wheel may be displayed in yellow. In this case, a change in the engagement state of the autonomous driving mode from a stable state to an unstable state may be reflected by a change in the color of the virtual steering wheel from green to yellow, in synchronization with the change in engagement state. Accordingly, the driver can intuitively recognize the necessity for partial intervention and can either perform partial driving through simple actions, such as holding the steering wheel, or switching to the manual driving mode.

During driving of the vehicle in the autonomous driving mode, the driving mode display device 800 may recognize the vehicle's driving state on the basis of the map data and the sensing information, which are received from the vehicle, and may display the vehicle's recognized driving state in synchronization with the virtual steering wheel (S1040).

At this point, recognizing the vehicle's driving state may include recognizing the vehicle's steering angle, the vehicle's turning, or movement direction, and the amount of rotational change in each wheel. Therefore, synchronizing the recognized vehicle's driving state with the virtual steering wheel refers to the display, by the driving mode display device 800, of an image of the rotating virtual steering wheel in synchronization with the vehicle's steering angle, the vehicle's turning direction, and the amount of rotational change in each wheel (including the extent of change and the direction).

In the autonomous driving mode, the vehicle may anticipate the vehicle's travel path, but may also detect objects (e.g., a vehicle, a lane, a two-wheeler, a traffic signal, a structure, a speed bump, a pedestrian, an animal, and other terrain features) in the vicinity of the vehicle during the driving of the vehicle. Accordingly, the vehicle may perform a driving maneuver (e.g., a lane change, a path change, a speed reduction, or the like) and/or provide a notification.

In the autonomous driving mode, since the vehicle is driven autonomously, the occupant may experience a sense of uncertainty when the vehicle suddenly changes lanes or takes a detour. Accordingly, the driving mode display device 800 may minimize a sense of apprehension and uncertainty that may be experienced by the occupant by controlling the virtual steering wheel either to perform a rotational motion (to simulate actual vehicle driving) or to display an associated notification.

Specifically, in some embodiments, the driving mode display device 800 may display the virtual steering wheel based on the sensing information detected through the steering wheel sensor of the vehicle 100 in a rotated and synchronized manner.

In some embodiments, the driving mode display device 800 may recognize whether a situation (take-over situation) requiring a change in the vehicle's driving mode occurs, based on the sensing information from the vehicle's autonomous driving sensor (refer to FIG. 8), the internal camera 220 (refer to FIG. 8), and the DMS 802 (refer to FIG. 8), and may display information associated with the recognized take-over situation on or along with the virtual steering wheel.

For example, in a case where it is anticipated, based on the received map information and the sensing information from the autonomous driving sensor, that the vehicle will enter an area where the vehicle 100 cannot be driven in the autonomous driving mode, the driving mode display device 800 may display, as the virtual steering wheel, information associated with the recognized take-over situation.

In addition, for example, in a case where a sudden change in the vehicle's driving state is anticipated based on a received vehicle driving control command, the driving mode display device 800 may display information associated with the recognized situation, along with the virtual steering wheel. At this point, examples of the vehicle driving parameters may include longitudinal and lateral acceleration (automatic aggressive, comfort, or eco), maintained inter-vehicle distance (desired distance), driving speed, auto lane change, lane offset driving, and similar parameters.

In another embodiment, the driving mode display device 800 may detect the engagement state of the vehicle's autonomous driving mode and further display a visual image, representing the engagement state of the detected autonomous driving mode, on the virtual steering wheel.

For example, in a case where the engagement state of the autonomous driving mode is satisfactorily established, the virtual steering wheel may be displayed in green to indicate stability. Conversely, when the engagement state of the autonomous driving mode becomes unstable, the virtual steering wheel may be displayed in yellow. In addition, when the situation (take-over situation) requiring a switch from the autonomous driving mode to the manual driving mode is anticipated, the virtual steering wheel may be displayed in red to indicate a warning.

Accordingly, in the driving mode display device 800 according to the embodiment of the present disclosure, when the vehicle's autonomous driving starts, the virtual steering wheel is displayed to enable the driver to intuitively recognize the start of the autonomous driving, and a change in the vehicle's steering is displayed in synchronization with the virtual steering wheel, minimizing a sense of uncertainty and apprehension that may be experienced by the driver due to a sudden change in steering during the autonomous driving of the vehicle.

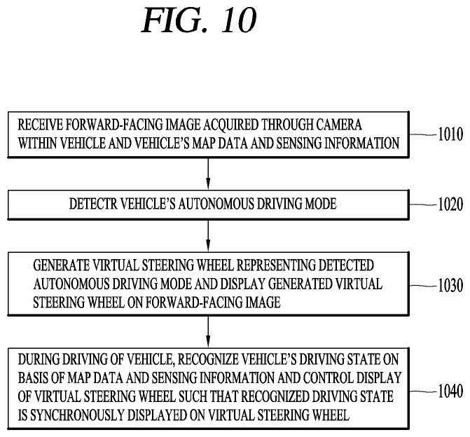

FIGS. 11A to 11C are views that are referenced to describe an operation scenario where the autonomous driving mode display device 800 detects the driver's entry into the vehicle and performs the auxiliary driving setting that matches the driver level of the driver.

The experience of undergoing autonomous driving varies for each driver who enters the vehicle 100. The auxiliary driving setting that matches the driver level refers to an auxiliary driving setting that matches a level that is determined based on the experience of undergoing autonomous driving. This level denotes to the driver's proficiency in using a system associated with autonomous driving and is distinguished from driving proficiency acquired through the driver's direct driving.

When it is recognized that the driver, occupant, or passenger (hereinafter referred to as the ‘occupant’) enters the vehicle, the driving mode display device 800 may perform an auxiliary driving setting that matches the detected occupant's driver level. For example, the driving mode display device 800 may perform an ADAS setting that automatically recognizes the driver and matches the recognized driver's driver level, thereby displaying a corresponding virtual GUI.

Specifically, when the driver's entry into the vehicle is detected, the driving mode detection unit 820 (in FIG. 8) of the driving mode display device 800 may detect an auxiliary driving setting that matches the detected driver level. To this end, the driving mode display device 800 may receive information concerning: the occupant's entry into the vehicle, the entry being recognized through various sensors within the vehicle 100; and the driver level that is set to match the occupant identified through facial recognition or similar biometric information.

Then, in accordance with the detected auxiliary driving setting, the processor 830 (in FIG. 8) of the driving mode display device 800 may display a virtual graphic object that represents the driving situation detected on the basis of the map data and sensing information of the vehicle 100, along with the virtual steering wheel,

As illustrated in FIG. 11A, after the vehicle 100 is started, the identification information of a registered passenger 1110 may be displayed.

After entering the vehicle is detected, as illustrated in FIG. 11B, when the occupant is identified through the internal camera and/or the DMS, an identification icon 1120 representing the identified occupant (e.g., ‘Lucy’) may be displayed.

Thereafter, when a predetermined period of time has elapsed or the autonomous driving mode is detected, as illustrated in FIG. 11C, an auxiliary driving setting 1130 that matches a user profile, for example, a profile named ‘Lucy,’ is displayed. For example, icons representing setting states, such as a level and range of information display and a pop-up setting, may be displayed on the auxiliary driving setting 1130.

In this manner, the screen may be configured using the advanced driver assistance system (ADAS) setting that is appropriate to the driver level, thereby enabling the driver to more easily recognize the provided information.

Next, as illustrated in FIG. 11D, a driving guidance screen 1140 associated with the manual driving mode may be displayed on the cluster or HUD until the autonomous driving mode is selected (set). In addition to the driving-related information, such as the vehicle's speed information, a map (e.g., vehicle lanes, a navigation map, and similar map data), and the vehicle's travel path, infotainment information, such as music playback information, may be displayed on the driving guidance screen 1140.

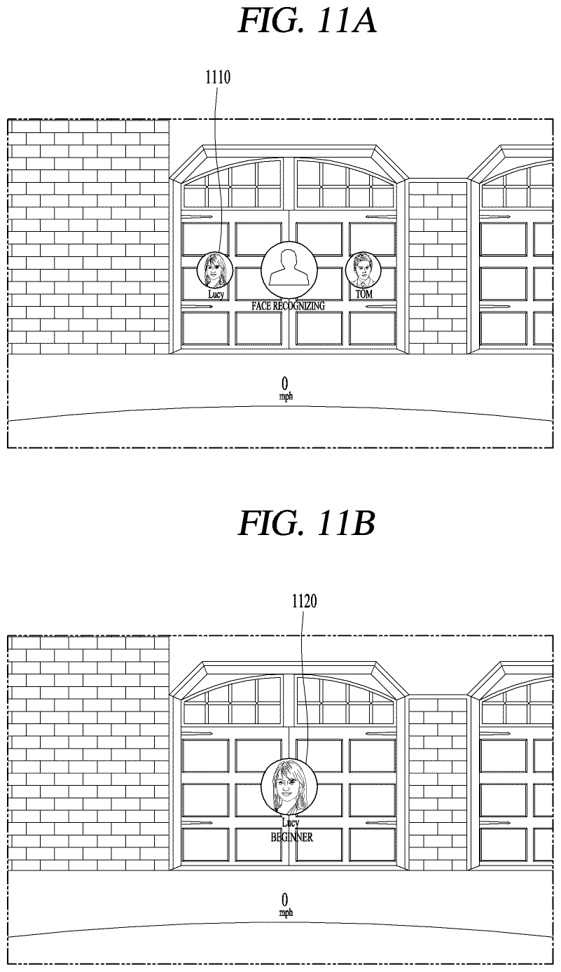

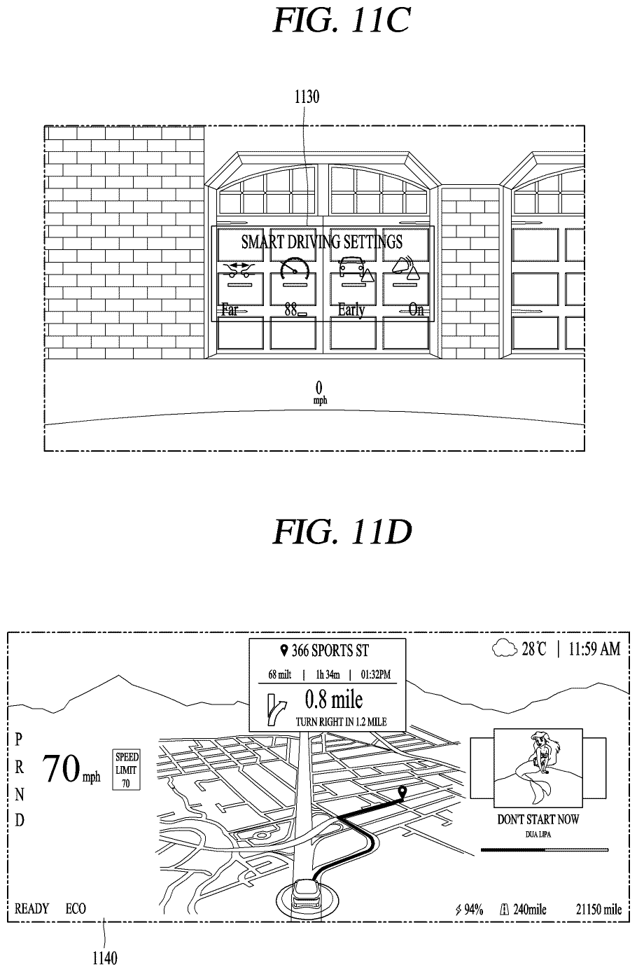

In a state where the driving guidance screen 1140 is displayed on the cluster or HUD, when the vehicle's autonomous driving mode is activated, a virtual steering wheel 1210 or 1310 may be displayed as illustrated in FIG. 12A or 13, respectively. The virtual steering wheel 1210 or 1310 may be displayed in a manner that varies in shape according to the type of autonomous driving mode.

FIGS. 12A and 12B are views that are referenced to describe a method of displaying the virtual steering wheel in the semi-autonomous driving mode in the driving mode display device 800.

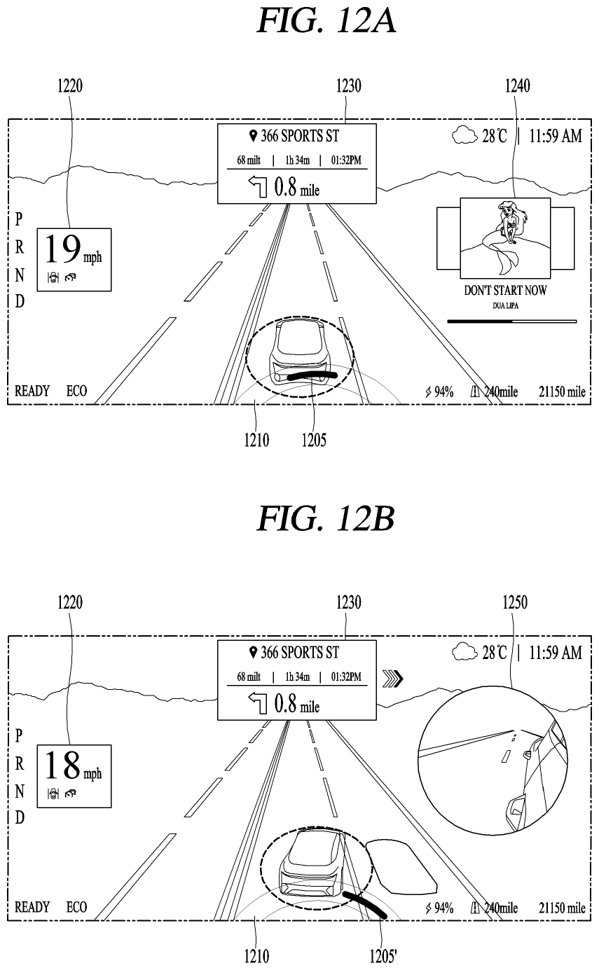

FIGS. 13 and 14 are views that are referenced to describe the virtual steering wheel in the fully autonomous driving mode in the driving mode display device 800.

The driving mode display device 800 may display a first virtual steering wheel 1210 in the semi-autonomous driving mode and may display a second virtual steering wheel 1310, different from the first virtual steering wheel, on the cluster or HUD in the fully autonomous driving mode.

With reference to FIGS. 12A and 12B, in the semi-autonomous driving mode, the driving mode display device 800 may display the first virtual steering wheel 1210 in the form of a translucent steering wheel. At this point, a movable graphic object 1205 in the form of a bar representing as a highlight marker may be displayed in color in one region of the space within the first virtual steering wheel 1210.

The movable graphic object 1205 in the form of a bar may be moved in the left-right direction within the first steering wheel 1210 in a synchronized manner based on the sensing information, such as the steering angle, from the steering wheel sensor. For example, the driving mode display device 800 may receive various types of sensing information from the vehicle 100 and control the display of a moving graphic object 1205′ within the first virtual steering wheel 1210 in synchronization with the received sensing information such that the moving graphic object 1205′ is rotated to the left or right, thereby assisting the occupant in obtaining a sense of visual stability and reducing a sense of uncertainty.

In addition, in the semi-autonomous driving mode, the current vehicle that is being driven (hereinafter referred to as a ‘virtual vehicle) may be displayed in the form of a virtual graphic object in front of the first virtual steering wheel 1210. At this point, the virtual vehicle may be moved to reflect the current driving state.

For example, when the vehicle 100 is about to move to the right-side lane, as illustrated in FIG. 12B, the first virtual steering wheel 1210 may be rotated to the right, and may be moved to the right simultaneously, before the rotation, or after the rotation. At this point, a shaded region may be displayed in an anticipated arrival region (e.g., the right-side lane) to which the virtual vehicle will move, thereby enabling the occupant to anticipate the location to which the vehicle is about to move. In addition, a virtual graphic object in the form of a shield may be continuously displayed in the vicinity of the virtual vehicle such that the driver can intuitively recognize the virtual vehicle as the vehicle that is being driven by the driver.

The driving mode display device 800 may also control the display of the virtual steering wheels 1210 and 1310 on the screen of the cluster or the CID.

Specifically, in the semi-autonomous driving mode, the first virtual steering wheel 1210, vehicle speed information 1220, and navigation information 1230 may be displayed on the cluster or HUD, and infotainment information 1240 or a camera image 1250 corresponding to the vehicle's travel direction may be displayed on the CID. At this point, the current vehicle's travel direction (e.g., the rightward travel direction) may be displayed adjacent to the navigation information 1230.

For example, while the vehicle is being driven straight ahead, the infotainment information 1240 is displayed on the CID. When the vehicle is about to move to the right-side lane, the shaded region is displayed on a road image on the cluster or HUD while the virtual vehicle is moving to the right-side lane, and the right-side camera image 1250 is simultaneously displayed on the CID screen.

Once the vehicle's lane change is completed, the right-side camera image 1250 disappears from the CID screen, and the infotainment information 1240 resumes being displayed. The virtual vehicle, the speed information 1220, and the navigation information 1230 may be continuously displayed on the cluster or HUD along with the first virtual steering wheel 1210.

With reference to FIG. 13, in the fully autonomous driving mode, the driving mode display device 800 may display the second virtual steering wheel 1310 in the shape of a steering wheel.

Specifically, while the vehicle is in the semi-autonomous driving mode, the driving mode display device 800 may display the first virtual steering wheel 1210 in the form of a translucent steering wheel. While the vehicle is in the fully autonomous driving mode, the driving mode display device 800 may display the second virtual steering wheel 1310 in the form of an (opaque) translucent steering wheel on the cluster screen. Accordingly, the occupant can intuitively recognize, based on a visual indicator in a visual manner, whether the current driving mode of the vehicle 100 is the semi-autonomous mode or the fully autonomous mode.

The driving mode display device 800, as illustrated in FIG. 13, may display a VR screen effect in the corner region of the cluster or HUD screen 1301 such that the driver can intuitively recognize that the current driving mode is the fully autonomous driving mode. At this point, simplified navigation information may be displayed on the cluster or HUD screen 1301 along with the vehicle speed information 1320.

In an embodiment, in the semi-autonomous driving mode, the driving mode display device 800 may display a second graphic object, representing surrounding environment information of the vehicle and a first graphic object, representing the vehicle's travel path and direction, along with the first virtual steering wheel. In addition, in the fully autonomous driving mode, the driving mode display device 800 may display the first graphic object, representing the vehicle's travel path and direction, along with the second virtual steering wheel 1310.

At this point, the first graphic object may be a (virtual) image object representing the vehicle's travel path and anticipated travel direction. In addition, the second graphic object may be a (virtual) image object that includes a notification regarding the surrounding environment information of the vehicle and information indicating an anticipated point and time for a change in the vehicle's driving state.

In addition, the driving mode display device 800 may display the cluster or HUD screen in the semi-autonomous driving mode and the cluster or HUD screen 1301 in the fully autonomous driving mode such that the configuration of the cluster or HUD screen in the semi-autonomous driving mode is different from the configuration of the cluster or HUD screen 1301 in the fully autonomous driving mode.

Specifically, since the vehicle 100 is driven independently in the fully autonomous driving mode, driving-related information may be displayed in a more concise manner in the fully autonomous driving mode than in the semi-autonomous mode. Accordingly, as described, in the full autonomous driving mode, speed information 1320 and information (e.g., an icon, an object, and similar indicators) indicating that the current driving mode is the fully autonomous driving mode may be displayed, but the camera image that corresponds to a change in the virtual vehicle's or the vehicle's travel direction may not be displayed on the cluster or HUD image 1301.

In addition, in the full autonomous driving mode, the cluster or HUD screen 1301 may be displayed in a visually enriched format. In addition, in the full autonomous driving mode, the second virtual steering wheel 1310 may be displayed in an entirely colored state.

At this point, various type of information associated with the autonomous driving mode may be displayed through the color displayed on the second virtual steering wheel 1310.

As an embodiment, the driving mode display device 800 may display the engagement state of the autonomous driving mode through the color displayed on the second virtual steering wheel 1310. For example, the driving mode display device 800 may display the second virtual steering wheel 1310 in green while the engagement state of the autonomous driving mode is satisfactorily established. In addition, when the connection status of the autonomous driving mode is detected to be unstable, the driving mode display device 800 may display the second virtual steering wheel 1310 in yellow.

In another embodiment, the driving mode display device 800 can inform whether the driver's intervention is required during the driving of the vehicle through the color displayed on the second virtual steering wheel 1310.

For example, during the activation of the fully autonomous driving mode, based on the detection of the driving situation (e.g., road conditions, weather conditions, an accident ahead, and the like) requiring the driver's temporary intervention or the switch to the manual driving mode, the driving mode display device 800 may alert the occupant to the driving situation by changing the color displayed on the second virtual steering wheel 1310, thereby prompting the occupant to perform the temporary intervention or to switch to the manual driving mode.

For example, during the driving of the vehicle in the autonomous driving mode, when a situation requiring the driver's intervention is detected, the driving mode display device 800 may change the color of the displayed second virtual steering wheel 1310 to yellow and additionally display a highlighting or animation effect to attract the driver's attention. At this point, the additionally displayed highlighting or animation effect may include information indicating the point in time and location at which the driver's intervention is required.

In addition, for example, during the driving of the vehicle in the autonomous driving mode, based on the detection of the occurrence of a hazardous or urgent situation on the road or in the vicinity of the vehicle, the driving mode display device 800 may display the second virtual steering wheel 1310 in red, thereby providing a signal or a notification indicating the urgent situation.

According to an embodiment, the driving mode display device 800 may display a change in the steering angle, the change being detected through the steering wheel sensor and/or the steering sensor in synchronization with the second virtual steering wheel 1310.

The driving mode display device 800 may receive the sensing information, including steering angle information of the vehicle, from the vehicle 100 and, based on the received steering angle information, may control the display of the virtual steering wheel, namely, the second virtual steering wheel 1310, such that the second virtual steering wheel 1310 is rotated in synchronization.

At this point, the processor 830 (in FIG. 8) of the driving mode display device 800 may synchronously display the vehicle's travel path, varying according to the rotation of the virtual steering wheel, on a forward-facing image displayed on the cluster or HUD.

For example, with reference to FIG. 14, while the forward-facing image 1301 is displayed on the cluster or HUD, the display of a movable graphic object 1305 or 1305′ within the second virtual steering wheel 1310 is controlled based on the received steering angle information such that the movable graphic object 1305 or 1305′ is moved to the left or right. At this point, the movement distance of the moving graphic object 1305 or 1305′ corresponds to the degree of steering included in the received steering angle information. Through this display control, the steering wheel is visually rendered to appear as rotating, thereby minimizing a sense of uncertainty that may be experienced by the occupant due to a change in the vehicle's steering angle.

Although not illustrated, in a case where various autonomous driving modes are set in the vehicle, the driving mode display device 800 may configure different virtual steering wheels corresponding to the respective set autonomous driving modes. In addition, the form of the virtual steering wheel may be customized on the basis of user settings within an allowable range. In this case, the driving mode display device 800 may display the virtual steering wheel customized on the basis of each detected autonomous driving mode.

The driving mode display device 800 according to the present disclosure is capable of enabling the driver to intuitively recognize the current engagement state of the vehicle's autonomous driving mode through changes in the display of the virtual steering wheel and to anticipate the point in time to switch to the manual driving and prepare for the switch to the manual driving mode.

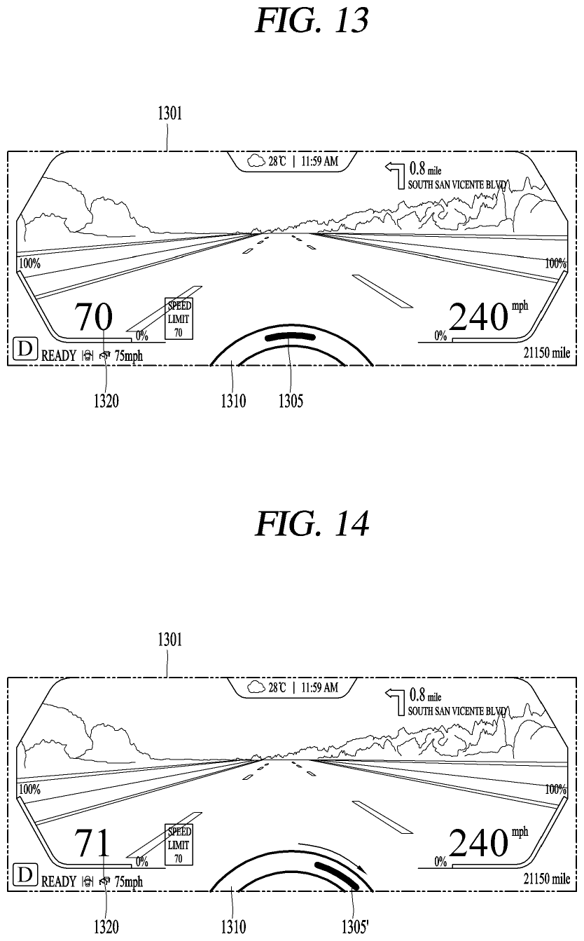

FIG. 15 is a view that is referenced to a method of providing the engagement state of the autonomous driving mode and information about a recognized object in the vicinity of the vehicle in the driving mode display device 800.

The processor 830 (in FIG. 8) of the driving mode display device 800 may detect the engagement state of the autonomous driving mode during the activation of the autonomous driving mode, and may additionally display the visual image, representing the engagement state of the detected autonomous driving mode, on the virtual steering wheel.

At this point, the visual image indicating the engagement state of the detected autonomous driving mode may include, for example, different images, textual indicators, and other elements in addition to the previously mentioned different colors (e.g., green, yellow, and red).

In addition, in an embodiment, the processor 830 of the driving mode display device 800 may recognize, based on the vehicle's received sensing information, that the engagement state of the autonomous driving mode is changed, and may display a visual image, indicating the changed engagement state, on the virtual steering wheel.

For example, in FIG. 15, when the vehicle-engaged state of the second steering wheel 1310, which is rendered on the forward-facing image displayed on the cluster or HUD, changes from a satisfactory state to an unstable state, the displayed color may change from green to yellow in synchronization. In addition, for example, when a situation requiring the driver's intervention is detected, the second virtual steering wheel 1310 may change to yellow and blink to attract the driver's attention. In addition, for example, when a hazardous situation of the vehicle 100 is detected, the second virtual steering wheel 1310 and the forward-facing image displayed on the cluster or HUD may change to red and blink to alert the driver.

In addition, in an embodiment, the processor 830 of the driving mode display device 800 may determine that the switch to the manual driving mode is required depending on the engagement state of the autonomous driving mode, and control the display of a virtual graphic image indicating the switch to the manual driving mode on the forward-facing image displayed on the cluster or HUD.

In addition, in an embodiment, the processor 830 of the driving mode display device 800 may display a graphic object, representing the results of detecting objects (e.g., another vehicle, a person, an obstacle, a lane, a traffic signal, a road, a structure, a speed bump, a terrain feature, an animal, and the like) in the vicinity of the vehicle, on the forward-facing image displayed on the cluster or HUD, along with an object (e.g., an icon 1501) indicating that the current driving mode is the autonomous driving mode.

At this point, the graphic object may be a rectangular image displayed along the detected object. In addition, the graphic object may be displayed to include situation information associated with the vehicle 100.

For example, with reference to FIG. 15, the driving mode display device 800 may display a first graphic object 1503 on an object that is monitored ahead of the vehicle 100 during the autonomous driving of the vehicle 100, namely, on a preceding vehicle. At this point, the display of the first graphic object 1503 may be controlled such that a notification is provided according to a separation distance from the vehicle 100. In addition, for instance, as illustrated in FIG. 15, during the autonomous driving of the vehicle 100, the driving mode display device 800 may display a second graphic object 1502 on an object present at the anticipated movement location, for example, on a preceding vehicle in a lane to which the vehicle 100 is expected to move.

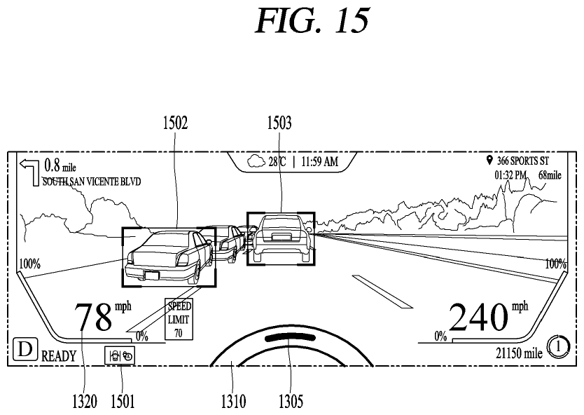

FIGS. 16A and 16B are views that are referenced to describe a method of displaying driving-related information, varying according to whether the current driving mode is the manual driving mode or the autonomous driving mode, in the driving mode display device 800.

FIG. 16A is a view illustrating an image 1601 that is displayed on the cluster or HUD in the manual driving mode of the vehicle 100, and FIG. 16B is a view illustrating an image 1602 that is displayed on the cluster or HUD in the autonomous driving mode of the vehicle 100.

In the manual driving mode, the driving mode display device 800 may display information for connecting the vehicle's travel path to the vehicle's current location. For example, with reference to FIG. 16A, the driving mode display device 800 may render and display a graphic object 1610, incrementally connecting the vehicle's current location and the vehicle's next anticipated location corresponding to the travel path, on the image 1601. At this point, the display of the graphic object 1610 may be controlled to move variably in correspondence with the vehicle's current location, travel path, and driving speed.

The driving mode display device 800 may display more driving-related information in the manual driving mode than in the autonomous driving mode to attract the driver's attention.

For example, with reference to FIG. 16A, the driving mode display device 800 may render and display a graphic object 1602 to prompt the driver to pay attention to an object requiring caution during the driving of the vehicle 100, the object being displayed on the image 1601. Examples of the object include an object associated with the travel path on the navigation screen and a traffic sign 1602. Examples of the object associated with the travel path may include an obstacle on the road. In this case, a graphic object representing a detour path, distinguishable from the graphic object 1610, may be additionally displayed.

When a switch from the manual driving mode to the autonomous driving mode occurs, the driving mode display device 800 may display the virtual steering wheel on the cluster or HUD.

In the autonomous driving mode, since the driver's duty to pay attention to the road ahead is reduced or eliminated, when the switch to the autonomous driving mode is detected, the driving mode display device 800 may control the display of information in the form of a graphic object on the cluster or HUD such that the amount of displayed information is decreased.

For example, with reference to FIG. 16B, in the autonomous driving mode, the driving mode display device 800 may display a graphic object 1620, representing only the vehicle′ travel path, on the image 1602. At this point, the graphic object 1620 may undergo tilting and/or rotation in synchronization with the vehicle's travel path and road conditions.

In addition, the driving mode display device 800 can control the display of the graphic object 1620 and the virtual steering wheel (e.g., the second virtual steering wheel 1310) on the basis of the vehicle's received sensing information and the map information, such that the graphic object 1620 and the virtual steering wheel are synchronized and changed accordingly.

In this case, the driving mode display device 800 may detect a road event (e.g., traffic congestion, an accident ahead, or the like) on the basis of the vehicle's received sensing information and the map information, and may display a notification indicating the event on the virtual steering wheel, the notification being synchronized with the timing of the detection. Then, the driving mode display device 800 may additionally propose a detour path, along with the graphic object 1620.

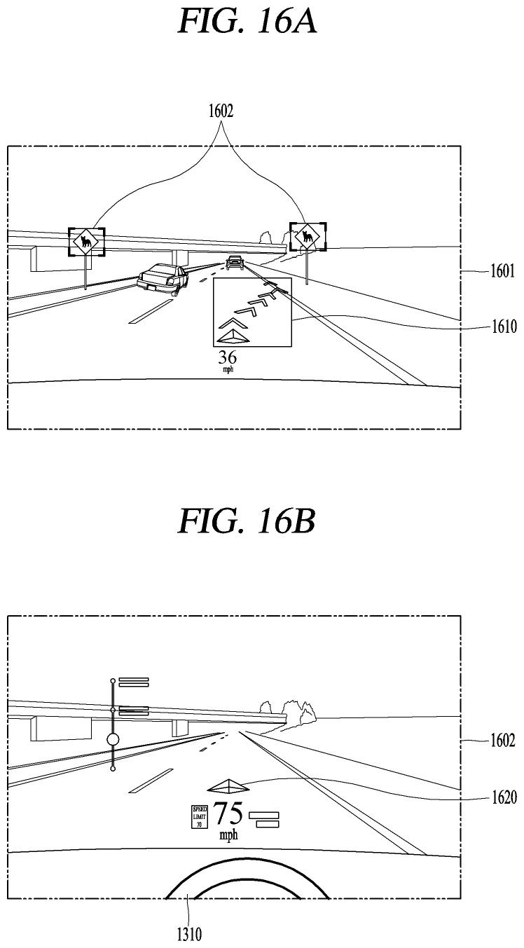

FIGS. 17A and 17B are views that are referenced to describe a method of displaying a warning on a per-risk level basis in the driving mode display device 800 during driving of the vehicle in the autonomous driving mode.

During the driving of the vehicle in the autonomous driving mode, the driver's duty to pay attention to the road ahead is reduced or eliminated. Therefore, in the autonomous driving mode, under normal circumstances, it is sufficient to provide only minimal information, along with the virtual steering wheel. However, in the autonomous driving mode, when an event such as a hazardous situation occurs, it is necessary to provide swift and intuitive information regarding the event, thereby enabling the driver to promptly become aware of the situation and to execute the driver's intervention.

Accordingly, the driving mode display device 800 may define (set) hazardous situations as having a plurality of levels in the autonomous driving mode. When an event is detected, the display of the event may be controlled to provide information within the extent or range appropriate to the defined level.

Specifically, the driving mode display device 800 may classify the hazardous situations into a plurality of levels based on the likelihood of collision, which is determined by the distance between the vehicle 100 and an object in the vicinity of the vehicle 100, and may display the level of risk on the object using a color that varies according to each level.

To this end, the driving mode display device 800 may display notification information for attracting the driver's attention, the information varying based on both the type of object corresponding to an event and the recognized level of risk.

For example, with reference to FIGS. 17A and 17B, while the virtual steering wheel 1310 is being displayed on the cluster or HUD, in a case where both a vehicle stopped on the shoulder and a person are detected, the driving mode display device 800 may recognize the occurrence of a hazardous situation event and may determine the recognized level of risk on the basis of the distance from the vehicle 100. In addition, the driving mode display device 800 may determine the level of risk based on the distance between the vehicle 100 and the preceding vehicle.

As illustrated in FIG. 17A, when the separation distance between the vehicle 100 and a preceding vehicle 1701 and/or between the vehicle 100 and an object 1702 corresponding to a hazardous situation is closer than the maximum value but falls within a first separation distance range (e.g., 10 to 30 m), the driving mode display device 800 may determine the level of risk to be ‘Caution.’

In this case, a first graphical object 1701 or 1702 for notifying the driver of the presence of the object may be displayed in a manner corresponding to the level of risk determined to be ‘Caution.’ For example, a color effect (e.g., yellow) indicating a caution condition may be applied to the first graphic object 1701 or 1702.

As illustrated in FIG. 17B, when the distance between the vehicle 100 and the object 1702 corresponding to a hazardous situation falls below a first distance and reaches a second separation distance, the driving mode display device 800 may determine the level of risk to be ‘Risk,’ which is higher than ‘Caution.’

In this case, a second graphic object 1703 for notifying the driver of the presence of an object may be displayed in a manner corresponding to the level of risk determined to be ‘Risk.’ For example, a color effect (e.g., red) and a highlighting effect that indicate a risk condition may be applied to the second graphic object 1703.

Furthermore, for example, the driving mode display device 800 may apply a risk indication in a manner that varies depending on the detected object, for example, the type of vehicle (e.g., an automobile, a bus, a motorcycle, an electric scooter, or the like) As an example, an indication for attracting the driver's attention may be applied to the ‘bus’ in a modified manner, considering a correlation between the expected number of alighting passengers and the proximity of nearby stops.

In addition, for example, the driving mode display device 800 may apply different risk indicators on the basis of the current lane in which the vehicle 100 is located, a lane in which the detected object is located, and an anticipated path of the vehicle 100.

In this manner, during the driving of the vehicle, the driving mode display device 800 according to the embodiments of the present disclosure may provide the travel path and information recognized from surrounding road conditions in an easily recognizable format.

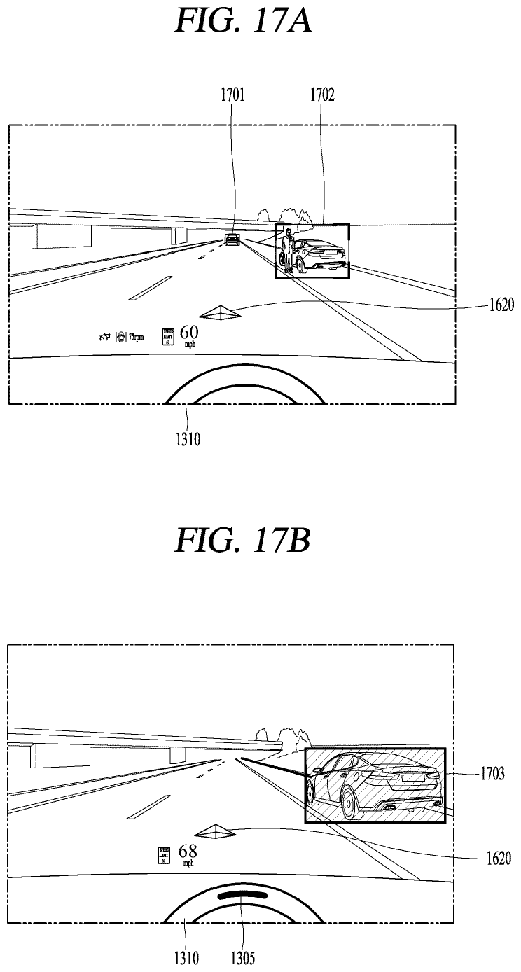

FIG. 18 is a view that is referenced to describe a method of displaying the detection of the driver's drowsiness state and providing guidance for the switch in the driving mode in the driving mode display device 800.

The driving mode display device 800 may receive the driver state information on the basis of the driver's biometric information (e.g., heart rate information based on facial blood flow, which is obtained by the IMS, the DMS, or a similar system, gaze information, and other similar information) during the driving of the vehicle 100 in the manual driving model or the autonomous driving mode. At this point, the driver state information includes the driver's stress state, fatigue state, drowsiness state, and concentration or non-concentration state.

At this point, the driver monitoring system (DMS) and/or the interior monitoring system (IMS), which serve as driver or occupant monitoring systems, may identify the driver or occupant's face and track the eyeball using a laser-equipped camera for the driver or occupant. The DMS and/or the IMS may monitor the driver's state on the basis of data (e.g., blinking, head angle, facial blood flow, forward gaze, off-road gaze, yawning, drowsiness, smoking, distraction, non-distraction, or the like) collected through the laser-equipped camera for the driver or occupant. For example, the DMS and/or the IMS may monitor emotional states, such as tension, fear, and stress, based on a change in the facial expression of the identified driver and the facial blood flow thereof.

The reception unit 810 of the driving mode display device 800 may receive the driver state information on the basis of the internal camera 220 (in FIG. 8) within the vehicle.

Since the manual driving mode of the vehicle 100 requires the driver to maintain forward gaze, the driving mode display device 800 may determine, on the basis of the received driver state information, whether the driver is performing driving properly, and, on the basis of the determination, may control various operations to be performed.

In an embodiment, the processor 830 of the driving mode display device 800 may display a virtual graphic object, providing guidance for the switch to the autonomous driving mode, on the forward-facing image based on the driver state information received while the vehicle's autonomous driving mode is not detected. For example, the driving mode display device 800 may display notification information providing guidance for the switch to the driver's autonomous driving mode based on the detection of the driver's drowsiness state in the manual driving mode.

During the driving of the vehicle 100 in the autonomous driving mode, the driver's duty to maintain forward gaze is eliminated or reduced. However, in a hazardous situation or a situation where the engagement state of the autonomous driving mode is unstable, the driver's intervention or the switch to the manual driving mode may be required.

Accordingly, during the autonomous driving mode, the driving mode display device 800 may also monitor the driver's or occupant's state through the DMS 802 (in FIG. 8) and/or the IMS of the vehicle 100, and, based on the result of the monitoring, may display, on the cluster or the HUD, notification information that provides guidance for the driver's intervention or the switch to the manual driving mode.

With reference to FIG. 18, in the autonomous driving mode, the driving mode display device 800 may display the virtual steering wheel 1310 and a first graphic object 1620, which guides the vehicle's travel path, on the cluster or the HUD. Additionally, the driving mode display device 800 may display a second graphic object 1801 on an object detected related to driving.

Along with this, the driving mode display device 800 may receive the driver state information monitored by the internal camera 220 within the vehicle 100, as well as by the DMS and/or the IMS. When the received driver state information corresponds to a fatigue state, the driving mode display device 800 may display an expression icon 1810 representing the fatigue state. At this point, the expression icon 1810 may be displayed adjacent to the virtual steering wheel 1310. In addition, a color effect (e.g., yellow) indicating a caution condition (e.g., a fatigue state) may be applied to the virtual steering wheel 1310.

As another example, the display of the expression icon 1810 may be changed such that expressions (e.g., drowsiness, distraction, and the like) corresponding to the driver's various detected states are displayed.

The driving mode display device 800 may detect the occurrence of an event corresponding to a hazardous situation of the vehicle 100, and may display notification information that provides guidance for the switch from the autonomous driving mode to the manual driving mode or the driver's temporary intervention.

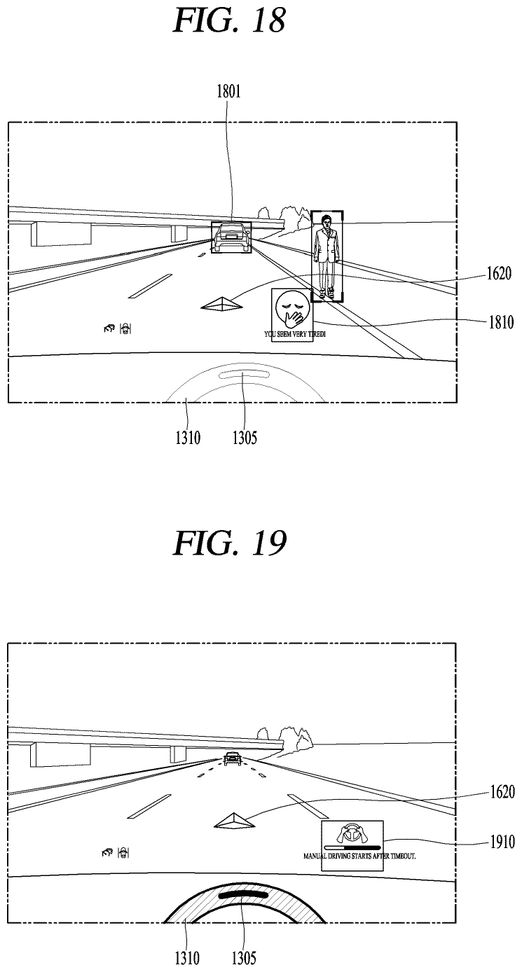

FIG. 19 is a view that is referenced to describe a method of providing a notification indicating the point in time for the switch to the manual driving mode in the driving mode display device 800 during the autonomous driving of the vehicle.

The processor 830 of the driving mode display device 800 may determine that the switch to manual driving mode is required depending on the engagement state of the autonomous driving mode, or that the driver's temporary intervention or the switch to the manual driving mode is required when an event corresponding to a hazardous situation occurs.

In this case, the processor 830 may display a virtual graphic image indicating the switch to the manual driving mode on the forward-facing image displayed on the cluster or the HUD. At this point, the virtual graphic image indicating the switch to the manual driving mode may include visual information that indicates the point in time or location at which the switch thereto occurs,

With reference to FIG. 19, when the switch to the manual driving mode is determined to be required, the virtual steering wheel 1310 is displayed on the cluster or the HUD with a color effect indicating a ‘caution’ condition. Then, the virtual graphic image 1910 indicating the switch to the manual driving mode is displayed adjacent to the virtual steering wheel 1310.

An image object indicating the point in time for the stable switch to the manual driving mode, for example, an image object in the form of a bar, which indicates a remaining time that gradually decreases, may be displayed on the displayed virtual graphic image 1910.

While the virtual graphic image 1910 is being displayed, when the driver's switch to the manual driving mode is detected, the driving mode display device 800, in response to the detected autonomous driving mode, may no longer display the virtual steering wheel 1310 and may change the cluster or HUD screen in such a manner as to have a configuration that corresponds to the manual driving mode.

In an embodiment, while the virtual graphic image 1910 is being displayed, is displayed, based on the detection of a hand gesture on a physical steering wheel of the vehicle 100 or the virtual steering wheel, the processor 830 of the driving mode display device 800 may provide a control signal for the switch from the vehicle's autonomous driving mode to the manual driving mode in synchronization with the vehicle and the driving mode display device 800.

In this manner, the driving mode display device 800 according to the embodiments of the present disclosure may enable the driver to intuitively recognize the current engagement state of the vehicle's autonomous driving mode through a change in the display of the virtual steering wheel, and may accurately anticipate the point in time at which the switch to the manual driving mode is required and prepare for the switch thereto accordingly. Accordingly, during the driving of the vehicle in the autonomous driving mode, even if the driver does not maintain forward gaze, the driving mode may be stably changed in a seamless manner if necessary.

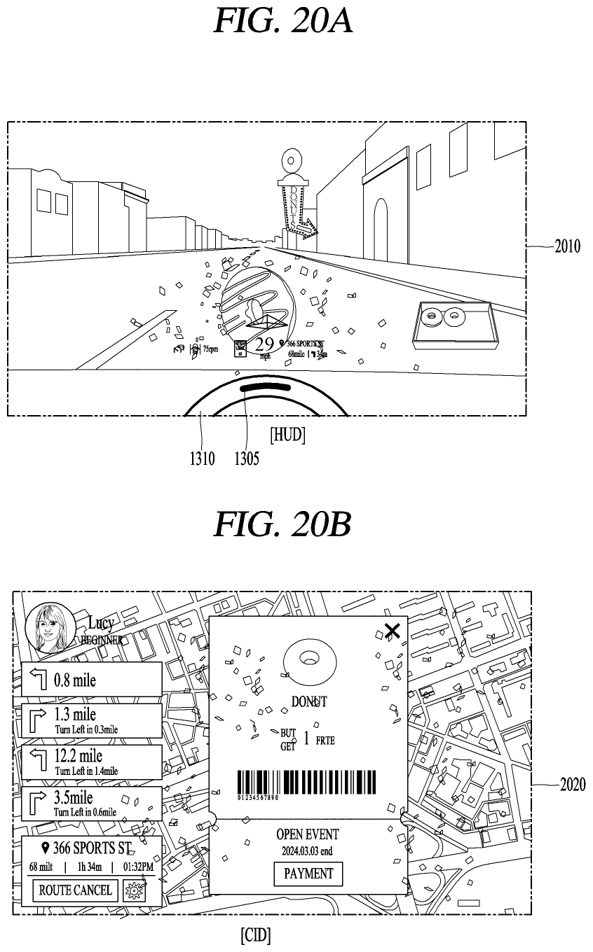

FIGS. 20A and 20B are views that are referenced to describe a method providing customized information to the driver during the driving of the vehicle in the driving mode display device 800.

During driving of the vehicle, the driving mode display device 800 may detect the presence of an event of interest to the driver on the vehicle's travel path on the basis of the sensing information of the vehicle 100, the map information, and external network information, and may display information, corresponding to the detected event, to a corresponding location along the vehicle's travel path.

At this point, the event may include, for example, discount information, giveaway event information, and various types of event information that are provided by a point of interest (POI) to the driver along the driver on the vehicle's travel path.

In addition, in a case where the event occurs along the driver's normal travel path, the driving mode display device 800 may propose an alternative path that guides the vehicle to the driver's normal travel path. At this point, the driving mode display device 800 may display the current travel path on the cluster or the HUD and display the alternative path on the CID.

In a case where the alternative path displayed on the CID is selected, the driving mode display device 800 may display event information, which is related to the event along the travel path, on the following travel path. In a case where the vehicle responds to the displayed event information, the driving mode display device 800 may display, on the vehicle's CID, the result of responding to the event information.

For example, FIG. 20A illustrates donut discount event information 2010, as the event information, on the vehicle's HUD, and FIG. 20B illustrates discount information 2020, acquired as a result of responding to the donut discount event information 2010, on the vehicle's CID.

Specifically, the driving mode display device 800 displays the vehicle's travel path and the virtual steering wheel 1310 on the HUD in the autonomous driving mode. The vehicle 100 recognizes information about ongoing sales promotion at a POI (e.g., a donut store) located along the travel path and frequently visited by the driver. The driving mode display device 800 receiving the recognized information displays event information, which is related to the information about the ongoing sales promotion, on the HUD. For example, as illustrated in FIG. 20A, when, as part of an AR game concept that utilizes event information related to the information about the sales promotion at the donut store, the vehicle follows AR donuts and collects one box of AR donuts, discount information, and a pop-up for a free coupon, as illustrated in FIG. 20B, may be provided in response to the collection.

The driving mode display device 800 may, if necessary, perform an automatic update after providing a notification of a software update. For example, in a state where the vehicle 100 is in a parked state, the driving mode display device 800 may display, on the vehicle's CID, a notification indicating that a software update is available for the driving mode display device 800. At this point, the driver may selectively input a point in time for the software update on the basis of an input to the CID. The software update notification displayed on the CID may be displayed on the cluster or the HUD through the driving mode display device 800 after it is detected that the driver has exited the vehicle. For example, after performing a security update, a camera vision sensor update, and other related updates, and providing an auto cruise subscription expiration notification, guidance on recommended subscription options (e.g., group driving), and other related notifications, an update completion notification may be transmitted to the driver's connected terminal device.

As described above, in the driving mode display device and the driving mode display method for vehicles, according to the present disclosure, when the vehicle starts the autonomous driving, the virtual steering wheel is displayed to enable the driver to intuitively recognize the start of the autonomous driving of the vehicle, and a change in the vehicle's steering is displayed in synchronization with the virtual steering wheel, thereby minimizing a sense of uncertainty and apprehension that may be experienced by the driver due to a sudden change in the vehicle's steering during the autonomous driving of the vehicle. In addition, the screen can be configured using the advanced driver assistance system (ADAS) setting that is appropriate to the driver level, thereby enabling the driver to more easily recognize the provided information. Furthermore, different settings can be provided for stages of the autonomous driving, thereby enabling the driver to intuitively recognize the current driving mode. Moreover, the current engagement state of the vehicle's autonomous driving mode can be intuitively recognized through a change in the display of the virtual steering wheel. The point in time at which the switch to the manual driving mode is required can be exactly anticipated, and preparations for the switch thereto can be made accordingly. Moreover, during the driving of the vehicle, the travel path and the information recognized from surrounding road conditions are provided in an easily recognizable format.

The present disclosure may be implemented in the form of computer-readable code recorded on a program-recorded medium. The computer-readable media include all types of recording devices capable of storing data that are readable by a computer system. Examples of media readable by computers include HDD (Hard Disk Drive), SSD (Solid State Disk), SDD (Silicon Disk Drive), ROM, RAM, CD-ROM, magnetic tape, floppy disk, and optical data storage devices. In addition, the examples encompass forms implemented as carrier waves (e.g., transmission via the Internet). In addition, the computer may also include a controller/processor of the driving mode display device 800. Therefore, the detailed description should not be interpreted in a limited manner in all respects, and should be considered as serving the purpose of illustration. The scope of the present disclosure should be determined by the proper interpretation of the following claims. All equivalent modifications to the embodiments of the present disclosure fall within the scope of the present disclosure.

1. A driving mode display device comprising:
a reception unit that receives a forward-facing image acquired through a camera within a vehicle, and the vehicle's map information and sensing information;
a driving mode detection unit that detects the vehicle's autonomous driving mode; and
a processor that generates a virtual steering wheel representing the detected autonomous driving mode and controls the generated virtual steering wheel to be displayed on the basis of the forward-facing image,
wherein the processor detects the vehicle's driving state on the basis of the map data and the sensing information during driving of the vehicle and controls the display of the virtual steering wheel such that the recognized driving state is displayed in synchronization with the virtual steering wheel.

2. The driving mode display device of claim 1, wherein the driving mode detection unit detects an auxiliary driving setting matching a recognized driver level when a driver's entry into the vehicle is detected, and
wherein, in accordance with the detected auxiliary driving setting, the processor displays a virtual graphic object representing a driving situation detected on the basis of the map data and the sensing information, along with the virtual steering wheel.

3. The driving mode display device of claim 1, wherein the processor selects an autonomous driving mode to be activated, based on the reception of a user input for selecting one autonomous mode from among a plurality of autonomous driving modes, and displays the visually distinguishable virtual steering wheel such that the selected autonomous driving mode is intuitively recognizable.

4. The driving mode display device of claim 3, wherein, in a first autonomous driving mode, the processor displays a first graphic object representing the vehicle's travel path and direction, along with a first virtual steering wheel, and, in a second autonomous driving mode, the processor displays the first graphic object and a second graphic object representing surrounding environment information of the vehicle, along with a second virtual steering wheel.

5. The driving mode display device of claim 1, wherein the sensing information includes steering angle information of the vehicle, and
wherein the processor changes the display of the virtual steering wheel on the basis of the received steering angle information such that the virtual steering wheel is rotated in synchronization.

6. The driving mode display device of claim 5, wherein the processor synchronously displays the vehicle's travel path, varying according to the rotation of the virtual steering wheel, on a forward-facing image.

7. The driving mode display device of claim 1, wherein the processor displays a visual image, representing an engagement state of the detected autonomous driving mode, on the virtual steering wheel.

8. The driving mode display device of claim 7, wherein the processor recognizes, based on the vehicle's sensing information, that an engagement state of the detected autonomous driving mode is changed, and displays a visual image, indicating the changed engagement state, on the virtual steering wheel.

9. The driving mode display device of claim 8, wherein the processor determines that a switch to a manual driving mode is required depending on the engagement state of the autonomous driving mode, and controls the display of a virtual graphic image indicating the switch to the manual driving mode on the forward-facing image.

10. The driving mode display device of claim 9, wherein the processor provides a control signal for the switch from the vehicle's autonomous driving mode to the manual driving mode to the vehicle based on the detection of a hand gesture on a steering wheel of the vehicle after the virtual graphic image is displayed on the physical steering wheel.

11. The driving mode display device of claim 1, wherein, when the vehicle switches to the manual driving mode while the virtual steering wheel is displayed, the processor no longer displays the virtual steering wheel on the forward-facing image.

12. The driving mode display device of claim 1, wherein the reception unit receives driver state information recognized on the basis of the camera installed within the vehicle, and
wherein, while the vehicle's autonomous driving mode is not detected, based on the received driver state information, the processor displays a virtual graphic object, providing guidance for a switch to the autonomous driving mode, on the forward-facing image.

13. An autonomous driving state display method comprising:
receiving a forward-facing image acquired through a camera within a vehicle, and the vehicle's map information and sensing information;
detecting the vehicle's autonomous driving mode;
displaying a virtual steering wheel, representing the detected autonomous driving mode, on the forward-facing image; and
displaying the recognized driving state in synchronization with the virtual steering wheel after recognizing the vehicle's driving state on the basis of the map data and the sensing information during driving of the vehicle.

14. The autonomous driving state display method of claim 13, further comprising:
detecting an auxiliary driving setting that matches a recognized driver level when a driver's entry in the vehicle is recognized; and
displaying a visual graphic object, representing a driving situation detected on the basis of the map data sensing information, along with the virtual steering wheel, in accordance with the detected auxiliary driving setting.

15. The autonomous driving state display method of claim 13, further comprising:
receiving a user input for selecting one autonomous driving mode from among a plurality of autonomous driving modes; and
selecting an autonomous driving mode to be activated based on the received user input and displaying the visually distinguishable virtual steering wheel such that the selected autonomous driving mode is intuitively recognizable.

16. The autonomous driving state display method of claim 13, wherein the sensing information includes the vehicle's steering angle information, and
wherein, in the displaying of the recognized driving state in synchronization with the virtual steering wheel, the display of the virtual steering wheel is changed on the basis of the received steering angle information such that the virtual steering wheel is rotated in synchronization.

17. The autonomous driving state display method of claim 13, wherein in the displaying of the virtual steering wheel, representing the detected autonomous driving mode, on the forward-facing image, a visual image representing an engagement state of the detected autonomous driving mode is displayed on the virtual steering wheel.
